(19) United States
(12) Patent Application Publication
(10) Pub. No.: US 2026/0148522 A1
(43) Pub. Date: May 28, 2026

(54) VEHICLE BASED THREAT LAUNCH DETECTION USING LONG WAVE INFRARED CAMERAS

(71) Applicant: BAE Systems Information and Electronic Systems Integration Inc., Nashua, NH (US)

(72) Inventor: Eric M. Louchard, Miami, FL (US)

(73) Assignee: BAE Systems Information and Electronic Systems Integration Inc., Nashua, NH (US)

(21) Appl. No.: 18/956,912

(22) Filed: Nov. 22, 2024

(51) Int. Cl. G06V 10/764; G06T 1/20; G06T 7/00; G06V 20/56

(52) U.S. Cl. CPC G06V 10/764; G06T 1/20; G06T 7/97; G06V 20/56; G06T 2207/10016; G06T 2207/10024; G06T 2207/10048; G06V 2201/07

(57) ABSTRACT

A computer program product interacts with machine-readable mediums with instructions for automated launch detection and recognition. It captures a video of a specified region using detectors on a vehicle. Raw image frames from the video undergo pre-processing, followed by feeding through anomalous clutter tracker pipeline, exceedance detection pipeline using global clutter suppression pipeline and an optical flow pipeline. Image windows are generated by rejecting clutter using exceedance pixel locations to create image chips of the target and local background that are run through a convolutional neural network, classifying them as launches or background clutter. A Kalman filter is applied to at least one frame detection list to generate a launch detection list and causes the launch to be detected.

### TECHNICAL FIELD

The present disclosure relates generally to automated target recognition and classification. More particularly, the disclosure relates to launch detection. In particular, the disclosure relates to vehicle based threat launch detection using longwave infrared cameras.

### BACKGROUND ART

Target detection identification and tracking systems have numerous military and non-military based applications. Specifically, automated target recognition (ATR), identification and tracking can be used in unmanned aerial vehicles such as drones and the like, and in military vehicles to locate, identify and track potential threats to the vehicle and or personnel nearby or within the vehicle.

Vehicles, regardless of whether they are manned or unmanned, in combat situations, or in civilian situations, face threats from all directions, but it is extremely difficult for a human operator of the vehicle to detect all possible threats and activate countermeasures. Some exemplary challenging threats are the launch of anti-tank guided missiles (ATGM) and rocket-propelled grenades (RPG) from the ground or from structures, as they can occur at any time of day from all directions. The FOGHAT system is designed to detect these launches using 360° SA long-wave infrared (LWIR) video cameras surrounding the vehicle with a full 360 degree field of view. FOGHAT is a project name for Interim Soft Kill System (ISKS). The 360° SA LWIR cameras have a 60 Hz frame rate and high resolution (1200×1920 pixels) and operate day or night, making them able to capture the initial launch frame and enough frames to measure the spectral signature to make the detection call and give the countermeasure system a chance to neutralize the projectile. The algorithms operate in real-time, detecting the launches while the vehicle is stationary or on the move and rejecting clutter caused by myriad heat sources in the environment.

Typically, these systems utilize one or more cameras and/or detectors to locate and identify nearby objects and or people and use tracking algorithms to determine characteristics or items to try to predict activity based on those detected characteristics. For example, automated driving systems may utilize one or more sensors to detect other vehicle, pedestrians, road lanes, road signs, or other objects or obstructions in the lane of travels. Unmanned vehicles, such as drones, may detect obstacles, the horizon, elevation, and or specific targets to follow and/or avoid. Military applications may utilize similar or enhanced systems to detect enemy personnel, vehicles, or the like or further to detect, identify, and counter or avoid threats such as incoming projectiles or other hostile objects.

These automatic target recognition (ATR) systems have improved over time. In particular, rapid advances in convolutional neural-networks (CNNs) may have made it possible to detect objects quickly and easily in video streams both with red green blue (RGB) video cameras and/or infrared cameras. The CNN may be customized and/or trained to detect objects based on target size, position, movement and/or thermal signature, particularly when utilizing infrared cameras.

Despite these advances in CNNs, most existing systems are highly accurate but are not suitable for real time use. However, one well-known system that is fast enough real-time use is a system known as YOLO (you only look once). Yet most YOLO systems are designed for low resolution video with a window-based region interest systems which can serve to limit the target size that can be detected. Further, a limited number of windows may be analyzed with the CNN before the system slows down to below real-time speeds. Thus, existing systems are limited in their ability to be used in real-time and/or their abilities for true day and night dual capability, either by their processing speed or by their limitations on video resolution and/or window based anchor box systems.

### SUMMARY OF THE INVENTION

The present disclosure addresses these and other issues by providing a high-resolution long wave infrared imaging system utilizing a custom CNN with a window-based detector for target launches in real time. In one example, the present disclosure relates to threat detection and tracking utilizing long wave infrared cameras and one or more CNNs. Specifically, in another example, the present disclosure may provide to platform, a system and method for vehicle based threat detection, tracking with long wave infrared cameras mounted on top of vehicles utilizing pixel based detectors, and image window based detectors to recognize, identify, and track both long and short-range targets.

In one aspect, an exemplary embodiment of the disclosure provides a computer program product including one or more non-transitory machine-readable mediums encoded with instructions encoded thereon that when executed by one or more processors cause a process to be carried out for automated launch detection and tracking, the instructions comprising: capture, via at least one detector, a sequence of image frames that depict a region of interest (ROI); process the sequence of image frames with an anomalous clutter tracker (ACT) pipeline, to detect at least one launch in the sequence of image frames in or near the ROI; apply a machine learning technique to the sequence of image frames to classify the at least one launch therein; generate at least one frame detection list containing data about the at least one launch; and apply at least one clutter tracker filter to the at least one frame detection list to generate a detection list including the at least one launch, wherein the at least one launch is detected in response to a detection in a video of the ROI, and causing the at least one launch to be detected. In this exemplary embodiment or another exemplary embodiment, a machine learning technique may be a CNN. In this exemplary embodiment or another exemplary embodiment, the instructions may further comprise: process a sequence of image frames through an exceedance detection (ED) pipeline using a global clutter suppression (GCS) routine and an optical flow pipeline (OFP); combine an output of an ACT pipeline with the output of the EDP to enter a clutter rejection (CR) pipeline; and generate a frame array from the ACT pipeline and from the EDP. In this exemplary embodiment or another exemplary embodiment, the instructions may further comprise: process raw image frames through a clutter rejection (CR) pipeline; filter a set of image windows from the raw image frames in the CR pipeline; and group the set of image windows into a batch and apply the machine learning technique to the batch to classify the at least one launch therein. In this exemplary embodiment or another exemplary embodiment, the instructions may further comprise: determine and filter cluster exceedances; create a batch of image chips from filtered cluster exceedances in the CR pipeline; and create a batch of non-redundant image chips from the ACT and GCS pipelines. In this exemplary embodiment or another exemplary embodiment, the instructions may further comprise: create detection and background windows; extract flow vectors from the detection and background windows; determine and apply a brightness threshold; and locally suppress clutter based on a signal to noise ratio (SNR) threshold. In this exemplary embodiment or another exemplary embodiment, the instructions may further comprise: provide initial flow vectors from the OFP, wherein the OFP comprises instructions to: enhance contrast of a test frame image; calculate pixel flow of the test frame image; and create flow vector maps based on pixel flow. In this exemplary embodiment or another exemplary embodiment, the instructions may further comprise: extract a target spectrum with an updated flow adjustment; compare a generalized likelihood ratio test (GLRT) calculation target to a library of stored exceedance images; apply a GLRT threshold; filter matches to clutter spectra based on GLRT spectra; and filter detections on clutter tracks. In this exemplary embodiment or another exemplary embodiment, the instructions may further comprise: populate a launch detection list. In this exemplary embodiment or another exemplary embodiment, the instructions may further comprise: capture a video from at least two detectors, wherein a first detector is a RGB video camera and a second detector is a LWIR video camera. In this exemplary embodiment or another exemplary embodiment, the instructions may further comprise: detect a first target with a RGB video camera; and detect a second target with a LWIR video camera.

In another aspect, an exemplary embodiment of the disclosure provides a method of automated launch detection and tracking, the method comprising: capturing, via at least one detector, a sequence of image frames that define a video depicting a ROI; processing the sequence of image frames with an anomalous clutter tracker (ACT) pipeline, to detect at least one launch in the sequence of image frames in or near the ROI; processing the sequence of image frames with at least one of an ACT pipeline, and an ED pipeline using a GCS pipeline and an OF pipeline to detect at least one launch in the sequence of image frames in or near the ROI; applying a machine learning technique to the sequence of image frames to classify the at least one launch therein; generating at least one frame detection list containing data about the at least one launch; and applying at least one clutter tracker Kalman filter to the at least one frame detection list to generate a detection list including the at least one launch, wherein the at least one launch is detected in response to a detection in the video of the ROI, and causing the at least one launch to be detected. In this exemplary embodiment or another exemplary embodiment, the method further comprises: processing a sequence of image frames through an ED pipeline using a global clutter suppression (GCS) routine; and an optical flow pipeline (OFP); combining an output of the ACT pipeline with the output of the EDP to enter a clutter rejection (CR) pipeline; and generating a frame array from the ACT and from the EDP. In this exemplary embodiment or another exemplary embodiment, the method may further comprise: processing raw image frames through a clutter rejection (CR) pipeline; filtering a set of image windows from the raw image frames in the CR pipeline; and grouping the set of image windows into a batch and applying the machine learning technique to the batch to classify the at least one launch therein. In this exemplary embodiment or another exemplary embodiment, the method may further comprise: determining and filtering cluster exceedances; creating a batch of image chips from filtered cluster exceedances in the CR pipeline; and creating a batch of non-redundant image chips from the ACT and GCS pipelines. In this exemplary embodiment or another exemplary embodiment, the method may further comprise: creating detection and background windows; extracting flow vectors from the detection and background windows; determining and applying a brightness threshold; and locally suppressing clutter based on a SNR threshold. In this exemplary embodiment or another exemplary embodiment, the method may further comprise: providing initial flow vectors from the OFP, wherein the OFP comprises instructions to: enhance contrast of a test frame image; calculating pixel flow of the test frame image; and creating flow vector maps based on pixel flow. In this exemplary embodiment or another exemplary embodiment, the method may further comprise: extracting a target spectrum with an updated flow adjustment; comparing a GLRT calculation target to a library of stored exceedance images; applying a GLRT threshold; filtering matches to clutter spectra based on GLRT spectra; and filtering detections on clutter tracks. In this exemplary embodiment or another exemplary embodiment, the method may further comprise: populating a launch detection list. In this exemplary embodiment or another exemplary embodiment, the method may further comprise: capturing a video from at least two detectors, wherein a first director is a RGB video camera and a second detector is a LWIR video camera. In this exemplary embodiment or another exemplary embodiment, the method may further comprise: detecting a first target with a RGB video camera; and detect a second target with LWIR video camera. In this exemplary embodiment or another exemplary embodiment, the method may further comprise: continuously tracking the at least one target until the target meets a predetermined threshold for invisibility; and deleting the target from the list of targets to be tracked.

In this exemplary embodiment or another exemplary embodiment, the method may further comprise: recording the ROI with both the first detector and the second detector during the day; and recording the ROI with only the second detector during the night.

In this exemplary embodiment or another exemplary embodiment, the first detector further comprises a RGB video camera. In this exemplary embodiment or another exemplary embodiment, the second detector further comprises a LWIR video camera.

In this exemplary embodiment or another exemplary embodiment, the method may further comprise: continuously tracking the at least one target until the target meets a predetermined threshold for invisibility; and deleting the target from the list of targets to be tracked.

### BRIEF DESCRIPTION OF THE DRAWINGS

Sample embodiments of the present disclosure are set forth in the following description, are shown in the drawings and are particularly and distinctly pointed out and set forth in the appended claims.

FIG. 1 is an exemplary side elevation view of an automated target recognition system (ATR) according to one aspect of the present disclosure.

FIG. 2 is a block diagram of a convolutional neural network (CNN) ATR system according to one aspect of the present disclosure.

FIG. 2A is a block diagram of an image-frame buffer block of the CNN ATR system of FIG. 2 according to one aspect of the present disclosure.

FIG. 2B is a block diagram of an exceedance detection block of the CNN ATR system of FIG. 2 according to one aspect of the present disclosure.

FIG. 2C is a block diagram of an optical flow block of the CNN ATR of FIG. 2 according to one aspect of the present disclosure.

FIG. 2E is a block diagram of a threat isolation block of the CNN ATR of FIG. 2 according to one aspect of the present disclosure.

FIG. 2F is a block diagram of a detection frame buffer block of the CNN ATR of FIG. 2 according to one aspect of the present disclosure.

FIG. 2G is a block diagram of a temporal spectrum classification block of the CNN ATR of FIG. 2 according to one aspect of the present disclosure.

FIG. 3 is a graphical depiction of a flow vector map for an image of a scene.

FIG. 3A is an expanded graphical depiction of vector flow from FIG. 3.

FIG. 4 is a depiction of an exemplary target detection spectrum.

FIG. 5A is an exemplary target spectrum of an ATGM launch at 1000 meters from the spectrum library of the disclosure.

FIG. 5B is an exemplary target spectrum of a RPG launch at 1000 meters from the spectrum library of the disclosure.

FIG. 5C is an exemplary target spectrum of an ATGM launch at 3000 meters from the spectrum library of the disclosure.

FIG. 5D is an exemplary target spectrum of an ATGM launch at 500 meters from the spectrum library of the disclosure.

Similar numbers refer to similar parts throughout the drawings.

### DETAILED DESCRIPTION

A launch detection algorithm uses long-wave infrared cameras mounted on top of vehicles. The algorithm is based around a change-detection routine that identifies “exceedance” pixels that increase in intensity rapidly, then drop back down over a short number of frames. Each exceedance is tracked in a detection frame buffer to create a time-series spectrum that is matched to a library of launch spectra. Clutter is rejected before the frame buffer starts by using the exceedance pixel locations to create image chips of the target and local background that are run through a convolutional neural network or another machine learning technique, classifying them as launches or background clutter to filter out. Additionally, bright objects in the scene, such as the sun, fires, or bright light, are tracked and cross-referenced against any exceedances to filter out this type of clutter. Detections that pass through the filtering algorithms are saved to a contact list with frame data, the spectral signature and library match score.

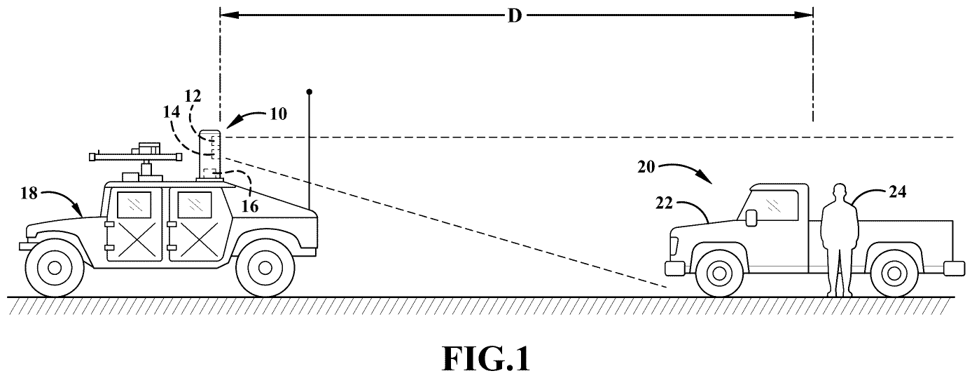

With reference to FIG. 1, an automated target recognition system (ATR) is shown and generally indicated at reference 10. ATR system 10 may generally include at least one detector, such as first detector 12. Typically, ATR system 10 is contemplated for use with two or more detectors, such as first detector 12 and second detector 14. ATR system 10 may further include at least one processor 16 in communication with first and second detectors 12 and 14 and in further communication with an additional processing system, storage media, and/or other similar components as dictated by the desired implementation. It is to be understood that the processing could be performed entirely on a platform, such as vehicle 18. Or, the processing performed by processor could be performed at a location different from the vehicle 18. If processing is performed off-vehicle, then a data link or communication link is needed to link the processor with the sensors.

Vehicle 18 can be any suitable vehicle including land-based vehicles, sea based vessels, aircraft, or space based vehicles, including manned and unmanned aircraft, or any other suitable or desired vehicle as dictated by the implementation of ATR system 10. Vehicle 18 may further be a stationary installation, including permanent and temporary installations, as desired. According to one example the vehicle 18 may in fact be a platform, building or cellular tower, and ATR system 10 may be installed thereon/therein as a security or monitoring system.

At its most basic, ATR system 10 may be utilized to detect, classify, and/or track a target, such as target 20, spaced at a distance away from ATR system 10. This distance is shown as distance D in FIG. 1.

As shown and discussed herein target 20 may be a target vehicle 22, a target person 24 (also referred to herein as a “dismount”), or any combinations of similar vehicles or persons as discussed further herein. However, the target 20 may be any other object that is to be detected.

As discussed in more detail below, first and second detectors 12 and 14 are contemplated to allow ATR system 10 to be utilized in both day and night conditions using a combination of infrared and/or RGB video detectors. Accordingly, first and second detectors 12 and 14 may be any suitable visual detectors including RGB video cameras, LWIR video cameras, mid-wave infrared (MWIR) video cameras or any other suitable visual detectors or suitable combinations thereof. According to one aspect, first detector 12 may be an RGB video camera and second detector 14 may be a LWIR camera. Similarly, first and second detectors 12 and 14 may be scaled and/or mounted within ATR system 10 to provide a wide angle or 360-degree view around vehicle 18 as discussed further herein. Accordingly, it will be understood that first and second detectors 12 and 14 may further include any suitable hardware and or mounting equipment such as gimbals and the like to maintain stability in the detectors while vehicle 18 is operated which further allowing movement of first and second detectors 12 and 14 as desired. As mentioned above, additional detectors beyond first and second detectors 12 and 14 may be included as dictated by the desire implementation of ATR system 10.

Processor 16 may be one or more suitable processors or processing units, including one or more logics or logic controllers along with one or more microchips and/or microcontrollers and may be in further communication with, or may otherwise include one or more storage media. Processor 16 may be utilized to simultaneously control the operations of first and second detectors 12 and 14 while further being operable to run a series of instructions thereon to analyze, detect, classify and/or track targets 20 using the methods and algorithms described further herein.

It will be understood that each of first detector 12, second detector 14, and/or processor 16 may be, or may further include, legacy components and/or systems which may be adapted for use with the ATR system 10 described herein. According to one aspect, first detector 12, second detector 14, and/or processor 16 may be existing components already carried or otherwise integrated into a vehicle 18 which may be modified, retrofitted or updated to include the operation and functionality described further herein in. According to another aspect, each of these components may be new dedicated components specifically designed and/or installed for use with ATR system 10 as described further herein.

As mentioned above and described further herein, target 20 including target vehicles 22 and/or dismounts 24 may be any type of target and may include land-based vehicles, sea-based vessels, aircraft, including manned and unmanned aircraft, weapons systems and/or projectiles, or any other suitable or desired target profile as dictated by the implementation of ATR system 10.

ATR system 10 may operate with a machine learning technique, such as a CNN, which may be utilized or trained in detection and recognition of targets 20 of interest. The CNN is a type of artificial neural network specifically designed for processing grid-like data, such as images and videos. It is useful for tasks like image recognition, object detection, and computer vision. CNNs are inspired by the organization of the animal visual cortex, which has specialized areas for processing visual information. Convolution is the fundamental operation in a CNN. A convolutional layer includes filters (also called kernels) that slide over the input image to perform convolutions. Each filter is a small matrix that extracts features from different parts of the input. Convolution helps the network detect patterns such as edges, textures, and shapes. After convolution, an activation function like ReLU (Rectified Linear Unit) is applied element-wise to introduce non-linearity in the network. This helps the model learn complex patterns and relationships in the data. Pooling layers downsample the spatial dimensions of the input while retaining essential information. Some exemplary pooling operations include max-pooling (selecting the maximum value in a local region) and average pooling (calculating the average value in a local region). After several convolutional and pooling layers, one or more fully connected layers are typically added. These layers connect every neuron in one layer to every neuron in the next layer, enabling the model to learn high-level features and make predictions. Before passing the output of the convolutional and pooling layers to the fully connected layers, the data is flattened into a vector. A softmax activation function may be used to produce a probability distribution over the different classes in a classification task. There may be a loss function that computes the error or difference between the predicted outputs and the actual labels. Some exemplary loss functions for classification tasks include categorical cross-entropy and mean squared error. To train the CNN, an optimization algorithm (e.g., stochastic gradient descent or another) may be used to minimize the loss function by adjusting the model parameters (weights and biases). This process involves backward propagation to update the weights in the network.

Although ATR system 10 is envisioned to utilize the CNN techniques detailed herein for detection and/or recognition of target 20, other machine learning techniques could be possible. For example, supervised learning techniques, such as support vector machines can be used for image classification and recognition. They work well with high-dimensional data and are effective when the number of dimensions exceeds the number of samples. In another example, random forests are an ensemble learning method that can perform both classification and regression tasks. It builds multiple decision trees and merges them to get a more accurate and stable prediction. Additionally, gradient boosting machines are another ensemble technique that builds an additive model in a forward stage-wise fashion; it allows for the optimization of arbitrary differentiable loss functions.

In other examples, unsupervised learning techniques, such as autoencoders are neural networks designed to learn efficient representations of the input data, called encodings, for tasks such as dimensionality reduction or feature learning. Another exemplary unsupervised technique is K-Means Clustering, which is a method that can be used to automatically partition the input data into clusters, which can then be used for object recognition. There is also principal component analysis, which is a statistical procedure that uses an orthogonal transformation to convert a set of observations of possibly correlated variables into a set of values of linearly uncorrelated variables.

In other examples, deep learning techniques, such as recurrent neural networks (RNNs) may be useful for sequential data and can be applied to tasks like object recognition in videos. Additionally, generative adversarial networks can be used for unsupervised learning tasks, including feature learning and anomaly detection in images.

As described herein ATR system 10 is contemplated for use in military applications with targets 20 of interest including vehicles 22, dismounts 24 and unmanned aerial vehicles (UAV).

Generally, the CNN-based ATR system 10 can continuously process incoming data, detect targets of interest accurately, and assist in making informed decisions based on the detected targets, ultimately enhancing situational awareness and aiding security and surveillance efforts. Generally, some embodiments of ATR system 10 may gather a diverse dataset containing images with examples of vehicles 22, dismounts 24, and UAVs. ATR system 10 may annotate the images, indicating the ROIs for each target category. ATR system 10 may preprocess the images, including resizing them to a consistent size, normalizing pixel values, and potentially augmenting the data to increase the diversity of the dataset. Augmentation techniques may include rotation, flipping, scaling, and changes in lighting conditions. ATR system 10 may include a CNN architecture having multiple convolutional layers for feature extraction, followed by pooling layers for down-sampling and reducing spatial dimensions. Some embodiments may use deeper architectures like ResNet, VGG, or custom-designed architectures tailored to a specific ATR task or application-specific need. The CNN may be trained using the preprocessed and annotated dataset. During training, the CNN learns to extract features that are relevant for distinguishing between different target classes (vehicles, dismounts, UAVs). The model can be trained to minimize a suitable loss function, such as categorical cross-entropy. ATR system 10 may validate the model on a separate dataset to assess its performance. ATR system 10 may fine-tune the model based on the validation results, adjusting hyperparameters or modifying the architecture to achieve better accuracy and generalization. Once the model is trained and validated, ATR system 10 may use it for inference on new unseen data. Input the images into the trained CNN, and the model will output predictions with bounding boxes and associated probabilities for the presence of each target class. ATR system 10 may apply post-processing techniques to refine the predictions, remove duplicate detections, and filter false positives. Common techniques include non-maximum suppression (NMS) to eliminate redundant detections and set a threshold on the confidence scores to filter out low-confidence detections. The trained CNN model may be integrated into the broader ATR system, allowing it to process real-time data streams, such as video feeds or image sequences. The ATR system will use the CNN's output to identify and track targets of interest (vehicles, dismounts, UAVs) and provide actionable insights or alerts accordingly.

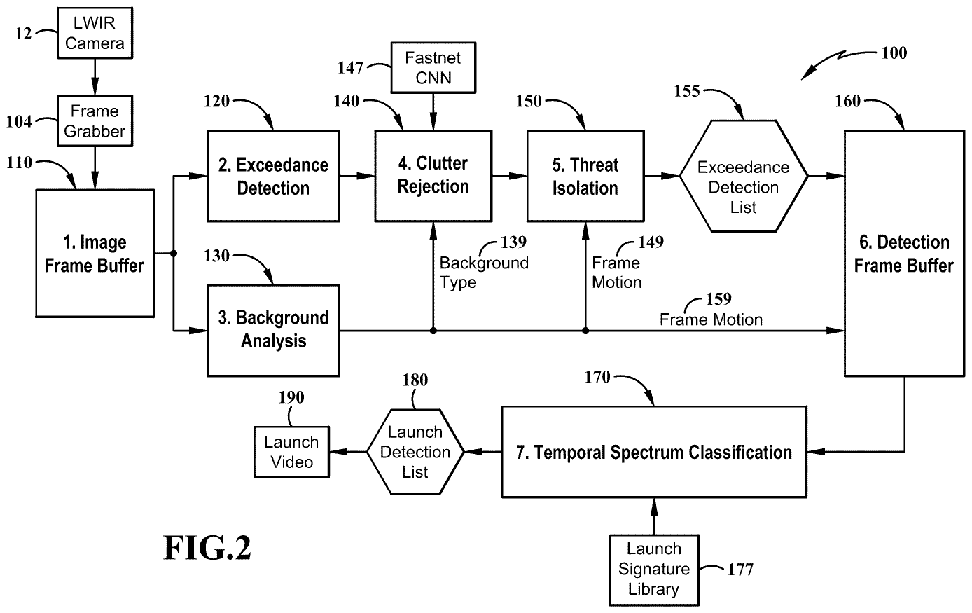

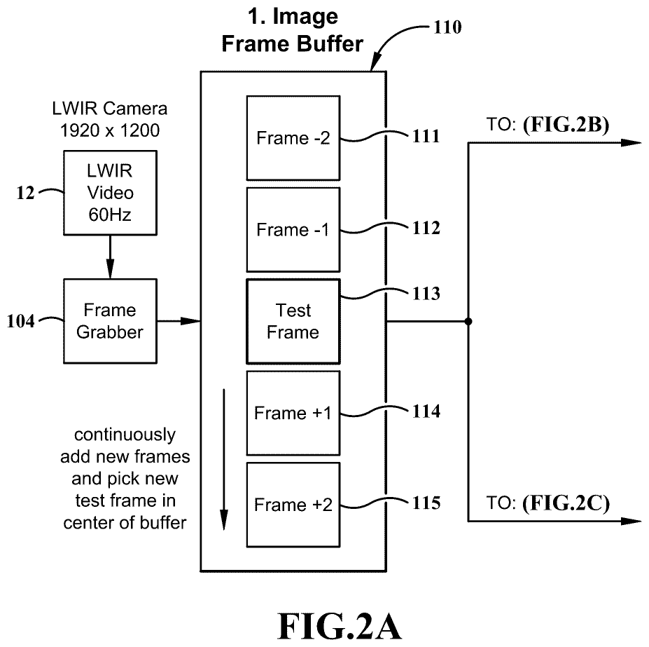

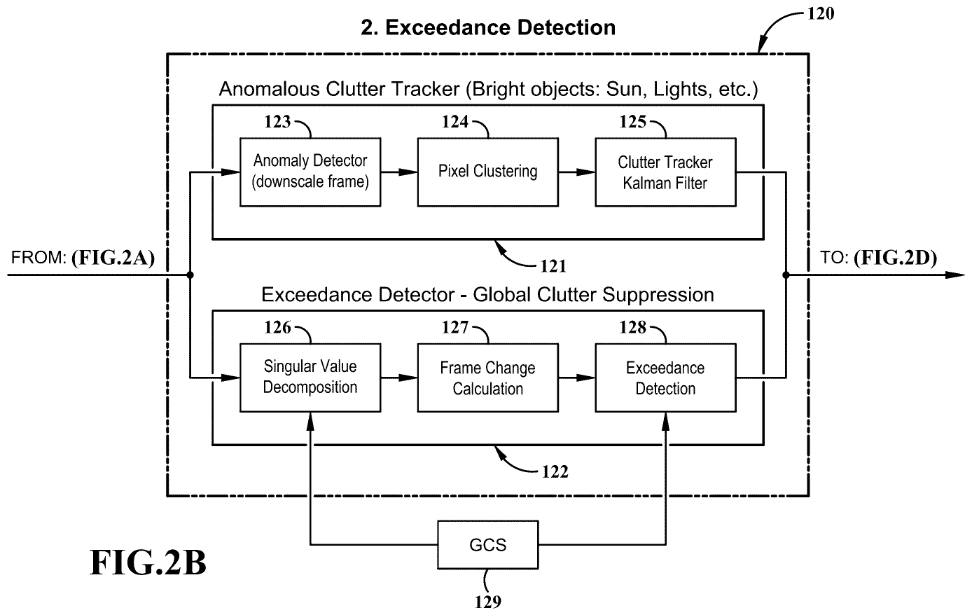

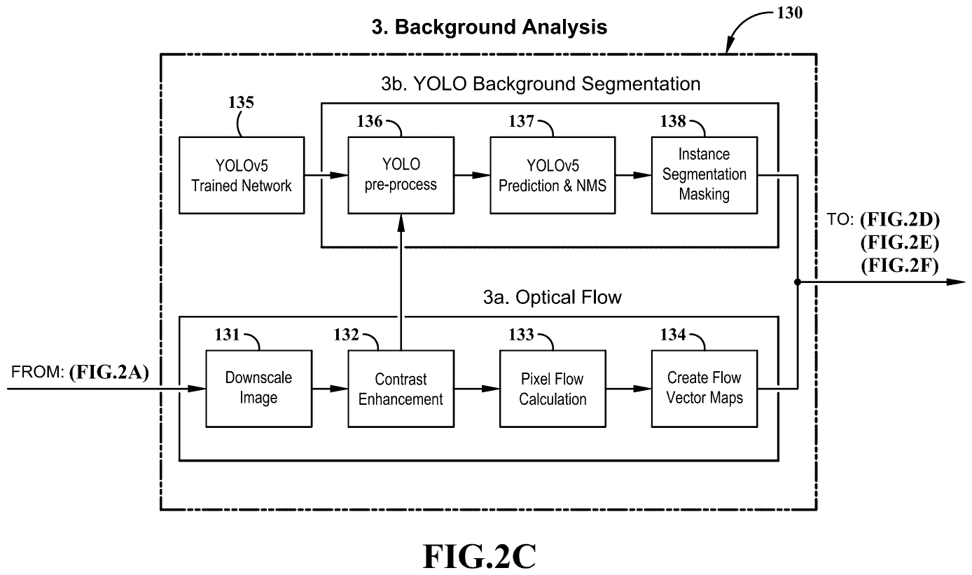

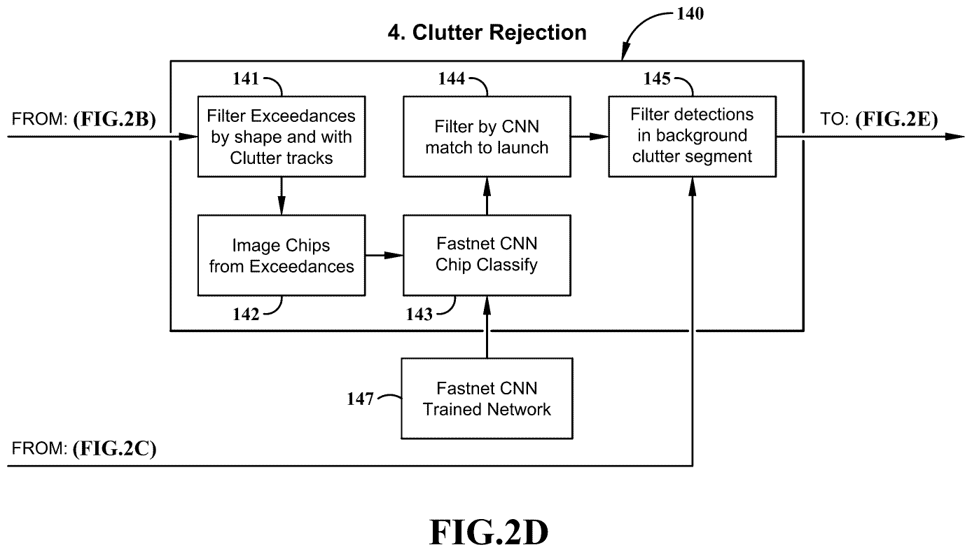

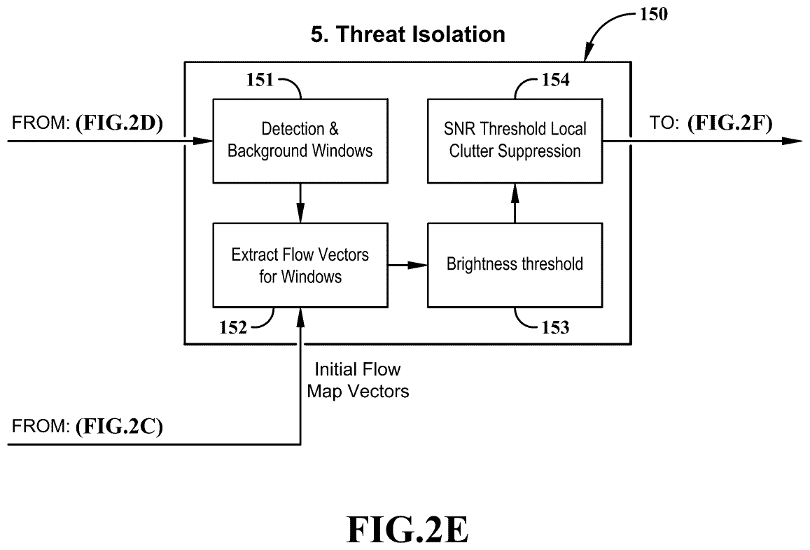

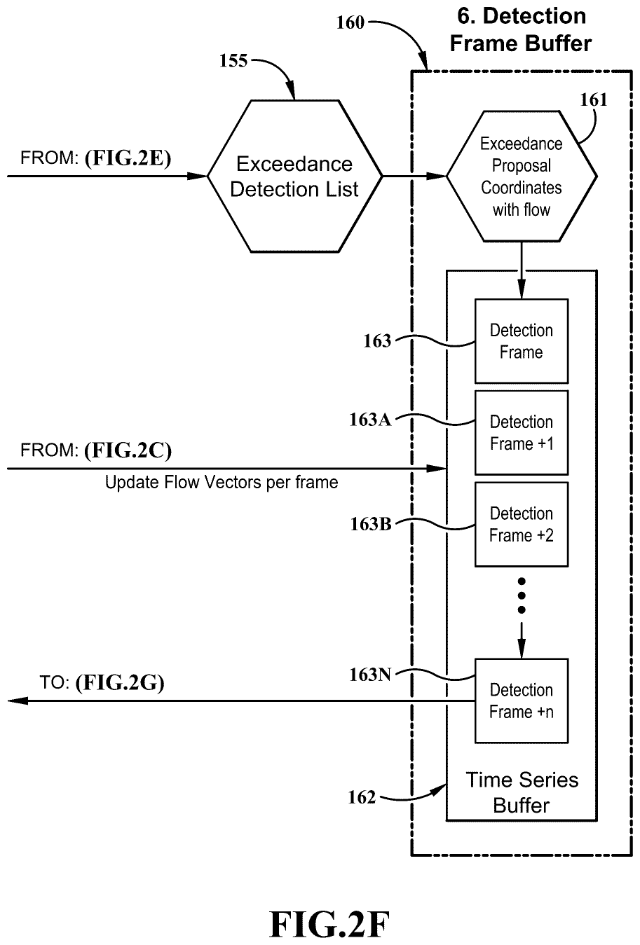

ATR system 10 in one embodiment includes a suite of algorithms and/or processes that use a pixel based detector for long range targets and an image window based detector for short range targets. These detectors may be any suitable detector such as those described above with relation to first and second detectors 12 and 14. As contemplated described herein a first detector may be an RGB video detector utilized for short-range image window based detections and second detector 14 may be LWIR video for long-range targets as a pixel-based detector. The suite of algorithms and/or processes are shown in FIG. 2 as general blocks which will be described in further detail below.

The functionality and processes of each block, as described below may work in unison to allow ATR system 10 to detect, identify, and track targets 20 which may further allow determination and/or classification of the targets which may be further used in threat avoidance, countermeasures, targeting systems, obstacle avoidance or the like.

ATR system 10, as mentioned above, may be divided into short-range and long-range target windows or target areas. While this case may vary in terms of defined position and relevant to the vehicle 18 utilizing ATR system 10, these detection zones may be delineated by distance D as seen in FIG. 1. In one example, the short-range targets are at distance D less than approximately 150 meters from vehicle 18 and long range targets are located at distance D greater than 150 meters from vehicle 18. In addition, or alternatively, these zones may be physically delineated by physical markers with the horizon being contemplated as the standard physical marker. Put another way, targets such as UAVs and other airborne targets are typically expected to be detected above the horizon or just slightly below the horizon at extended distances and are typically detected utilizing the long range detector, while vehicles and dismounts are typically detected below the horizon. Where there is an overlap between these detector regions, redundant detection may be filtered out through suppression of ROI boxes with lower classification scores as described further below.

This disclosure describes the FOGHAT launch detection algorithm using LWIR cameras mounted on platforms such as vehicles. The algorithm is based around a change-detection routine that identifies “exceedance” pixels that increase in intensity rapidly, then drop back down over a short number of frames. Each exceedance is tracked in a detection frame buffer to create a time-series spectrum that is matched to a library of launch spectra. Clutter is rejected before the frame buffer starts by using the exceedance pixel locations to create image chips of the target and local background that are run through a convolutional neural network, classifying them as launches or background clutter to filter out. Additionally, bright objects in the scene, such as the sun, fires, or bright light, are tracked and cross-referenced against any exceedances to filter out this type of clutter. Detections that pass through the filtering algorithms are saved to a contact list with frame data, the spectral signature and library match score.

In one exemplary embodiment, the ATR algorithms have been designed for LWIR video with a single wavelength channel. Some exemplary targets 20 of interest are ATGMs and RPGs, though ATGMs are the bigger threat for vehicles. A diagrammatic flowchart 100 for the algorithm detection and tracking pathways is shown in FIG. 2.

There are seven exemplary components to the algorithm flowchart 100 as described in detail below. To summarize, ATR system 10 may utilize processor 16 to execute an image frame buffer block 110, an exceedance detection block 120, a background analysis block 130, a clutter rejection block 140, a threat isolation block 150, a detection frame buffer block 160, and a temporal spectrum classification block 170.

Referring to FIG. 2A, one component of the algorithm flowchart 100 is the Image Frame Buffer Block 110. The first step to processing an image is to add frames from first detector (e.g., camera) 12, by way of Frame Grabber 104, to the Image Frame Buffer, which holds five frames in total: Frame −2, Frame −1, Test Frame, Frame +1 and Frame +2, which are items 111-115 respectively. First detector 12 may be any still or video camera operating in the LWIR band or other bands of the electromagnetic spectrum, such as visible, or RGB. An exemplary first detector is camera 12 which is LWIR having a resolution of 1920×1200 pixels with a refresh rate of 60 Hz. The center frame 113 in the buffer is the “Test Frame” that is used for the exceedance detection block 120; the background analysis block 130, and the clutter rejection block 140, to be discussed below). When the algorithms are initiated, the first five frames from the camera 12 are selected by frame grabber 104 and loaded to fill the buffer 110. When frame six is loaded, it replaces “Frame+2” 115 (frame 5 of the buffer—110), and the four frames from Frame+2 (115) to Frame−1 (112) are shifted back one space in the buffer. Stated otherwise, this operates in a First In First Out (FIFO) manner such that when the sixth frame is added, the first frame (i.e., Frame−2) drops out. This buffer 110 continues adding frames in this way, and as each new frame is added, the buffer contents is sent to the next stages of processing.

If any frame in the buffer has a percentage of pixels equal to zero greater than MIN_ZERO_FRACTION (default 0.05), the frame buffer is not processed. This avoids using frames while the camera automatic non uniformity correction (auto-NUC) is operating or if there are bad frames.

Referring further to FIG. 2, and also to FIG. 2B, another component of the algorithm flowchart 100 is the Exceedance Detection block 120. There are two pipelines in this processing block running in parallel: the anomalous clutter tracking pipeline 121 and the main exceedance detecting pipeline 122. The first pipeline 121 is a detector and tracker of bright anomalies, such as the sun or bright lights in a scene. The second pipeline is the exceedance detection block with GCS routine 129 which takes the Image Buffer contents (e.g., frames 111-115) together with calculated intensity changes for all pixels between the frames and identifies the coordinates of those that exceed a detection threshold.

The Anomalous Clutter Tracking pipeline 121 takes the Test Frame 113 from the Image Frame Buffer 110 and downscales it to increase processing speed.

The Anomaly Detector (downscaling) routine, 123, calculates the mean of the non-masked pixels, then segments the image into “Light” pixels above the mean and “Dark” pixels below the mean. The downscaling (routine 123) may be achieved with a default 0.25 downscale factor using nearest neighbor interpolation. Other downscale factors are possible, such as 0.1, 0.2, 0.3, 0.4, 0.5, 0.6, 0.7, 0.8, 0.9 and other values in between and less than unity. A mask is created for all pixels equal to zero (0), Not a Number (NaN) or Infinity (Inf), and the remaining pixels are analyzed using a Segmented Anomaly Detector; See Table 1.

TABLE 1
MatLab Parameters for Anomaly Detector and Clustering

| Parameter Name | Setting | Units | Description |
|---|---|---|---|
| clutterSnrThreshAd | 4 | — | SNR Threshold for the clutter AD_map |
| clutterMinArea | 2 | Pixels | Minimum area in pixels for a cluster to be tracked |
| clutterAxisThresh | 5 | Ratio | Maximum axis ratio for a cluster to be tracked |
| clutter_Min_Brightness | 1000 | DNs | Clutter objects must have this brightness threshold |
| | | | (target-background) pixel intensity to be tracked |

Submasks are made for each so they can be analyzed separately. For light segments or pixels, the submask has 0 for all pixels below the mean. For dark segments or pixels, the submask has 0 for all pixels above the mean.

Both the light and dark segments are analyzed using a routine to calculate the signal to noise ratio (SNR) of each pixel in the image using Equation 1, where only the unmasked pixels are used:

$$SNR = \sqrt{\frac{{( T - {B}_{mean} )}^{2}}{{( {B}_{std} )}^{2}}} \qquad ( 1 )$$

where T=Target Pixel Intensity, Bmean=Background spectrum, Bstd=Background standard deviation

The results from light and dark segments are filtered with a minimum SNR threshold (min_seg_SNR=2), and then the minimum value for each pixel from both segments is put into an array called AD_map, the anomaly map. The AD_map is thresholded again using the value in clutterSnrThreshAd before being sent to clustering.

For the Pixel Clustering routine 124, an AD_map array is clustered using a 2-D connected components algorithm with eight pixels of connection. Clusters are filtered by pixel area and general shape, removing spurious clutter objects to make a list of region proposals and draw boxes around them for analysis. Cluster statistics are determined by fitting a data ellipse to the pixel distribution within a detected cluster, C_{N}. The size and shape parameters are derived from the major and minor axes of the ellipse. It may be assumed that detection pixels of an underlying hard target are distributed according to a rectangular distribution function. The variance σ² and length L of a rectangular distribution are related by Equation 2:

$${σ}^{2} = \frac{1}{12} {L}^{2} \qquad ( 2 )$$

The length and width of the hypothesized target object producing the detected cluster C_{N} can be determined from the variance of the distribution of pixels within the cluster. A (2×2) spatial covariance matrix can be defined and is associated with the cluster C_{N} in Equation 3 as:

$$Σ ( {C}_{N} ) = ( \begin{matrix}{σ}_{row ( j )}^{2} & {σ}_{ij}^{2} \\ {σ}_{ij}^{2} & {σ}_{column ( i )}^{2}\end{matrix} ) \qquad ( 3 )$$

Where

$${σ}_{row ( j )}^{2} and {σ}_{column ( i )}^{2}$$

are the variance of the row and column indices in the cluster respectively and

$${σ}_{ij}^{2}$$

is the low-column convenance. Defining λ₁ and λ₂ as the eigenvalues of Σ(C_{N}) with λ₁≥λ₂ the major and minor axis statistics of the cluster are provided in Equation 4:

$$major\_axis = \sqrt{12 {λ}_{1}} \qquad ( 4 )$$

$$minor\_axis = \sqrt{12 {λ}_{2}}$$

Two additional statistics are computed from the above results:axis ratio and area ratio. The axis ratio is given by Equation 5:

$$axis\_ratio = \frac{major\_axis}{minor\_axis} \qquad ( 5 )$$

Additionally, the detection centroid (center pixel in the cluster) is given by Equation 6:

$$centroid column = {〈 {C}_{N} 〉}_{i} \qquad ( 6 )$$

$$centroid row = {〈 {C}_{N} 〉}_{j}$$

A final parameter, Brightness, is calculated as difference between the DN value from the Test Frame at the centroid coordinates and the mean of the “Light” pixels used in anomaly detection. DNs are digital numbers, which are values related to bit depth. A range of DNs for 8-bit data is 0 to 255, while for 16-bit data the range is 0 to 65535.

Clusters are saved in a list of Threat Locations for further processing in the clutter rejection block 140. Each cluster includes metadata for Pixel Area and Axis Ratio (ratio or major and minor axis length). Each cluster has its area and centroid scaled back into the original pixel dimensions, then is compared to different thresholds to be added to the final detlist_clutter array. Clusters must have an Area greater than or equal to than clutter_Min_Area, an Axis Ratio less than or equal to clutter_Axis_Thresh and Brightness greater than or equal to clutter_Min_Brightness (i.e., the brightness threshold).

The detlist_clutter parameters from MatLab are shown in Table 2 below.

TABLE 2

| Row | Column | Area | Major Axis | Minor Axis | Axis Ratio | SNR | Brightness |
|---|---|---|---|---|---|---|---|
| 225 | 1104 | 368 | 22.11 | 21.93 | 1.01 | 47.09 | 31969.39 |

With continued reference to FIG. 2B, the Kalman filter used in Clutter Tracker routine 125 may utilize the Hungarian method costs matrix, where new detections are compared to existing tracks to find the lowest “costs” a value that account for Euclidean distance and pixel area differences. Unassigned tracks may continue with the same states until they reach the threshold for invisibility and are then deleted. Put another way, these targets will continue to be tracked until they are no longer detectable, at which point they are deleted. The equations for the Kalman filters are:

Time Update (“Predict”)
(1) Project the state ahead
${\hat{x}}_{k}^{-} = A {\hat{x}}_{k - 1} + {Bu}_{k}$
(2) Project the error covariance ahead
${P}_{k}^{-} = {AP}_{k - 1} {A}^{T} + Q$
Measurement Update (“Correct”)
(1) Compute the Kalman gain
${K}_{k} = {P}_{k}^{-} {{H}^{T} ( {HP}_{k}^{-} {H}^{T} + R )}^{- 1}$
(2) Update estimate with measurement 2
${\hat{x}}_{k} = {\hat{x}}_{k}^{-} + {K}_{k} ( {z}_{k} - H {\hat{x}}_{k}^{-} )$
(3) Update the error covariance
${P}_{k} = ( I - {K}_{k} H ) {P}_{k}^{-}$

and the initial estimates for \hat{x}ₖ₋₁ and Pₖ₋₁.

Table 3 presents MatLab parameters for the Kalman filter.

TABLE 3
MatLab Kalman Filter parameters for clutter tracker

| Parameter Name | Setting | Units | Description |
|---|---|---|---|
| clutterKalAgeThreshold | 1 | Frames | Age in frames for a track to become “official” |
| clutterVisThreshold | 0.03 | Fraction | Visibility threshold (visible count / track age) to |
| | | | keep a track |
| clutterInvisibleForTooLong | 20 | Frames | Track is dropped if it is not visible for this number |
| | | | of frames |
| clutterCostOfNonAssignment | 25 | Pixels | Maximum distance of a new detection before it is |
| | | | not assigned to any existing tracks. |

Further referring to FIG. 2B, the Exceedance Detecting pipeline 122 uses GCS routine 129 that detects changes in intensity within the Image Frame Buffer 110. Pixels that increase in intensity within the buffer 110 are identified as Exceedances; such pixels then pass to the next stage of processing.

The GCS routine 129 runs a Singular Value Decomposition (SVD) routine 126 on each pixel across the clutter frame set of the Image Frame Buffer 110 (Frames 1, 2, 4, 5; items 111, 112, 114, 115 around the Test Frame 113) to calculate the background clutter value. The SVD routine 126 uses an estimate of the previous frame's Ur matrix (the r principal left singular vectors to feed into the current frame's SVD calculation). Stated differently, the Ur matrix uses the previous frame's pixel characteristics to influence the current frame and to find pixels that are changing.

The SVD routine 126, assembles a matrix (cMat) with an exemplary size [numpix, 4] where numpix=1200*1920. This matrix holds frames 1, 2, 4, and 5 from the Image Frame Buffer 110. The SVD routine 126 uses this as an input with the Ur matrix, which is taken from the previous frame buffer SVD analysis of Test Frame 113. The Matlab function for calculating SVD values is [Ur,svals]=fast(Ur,cMat)

The steps for fast SVD from Matlab are:
x=cMat (:,4); % get the most recent data vector
a=Ur′*x; % find its projection onto each of the left singular vectors in Ur.
res=x−(Ur*a); % compute the residual data vector
nres=norm(res); % compute norm of residual data vector
ures=res./nres; % compute a unit vector from the residual
avec=(Ur′*DataMatrix(:,1:col−1)); % compute the projection coefficients onto Ur
amat=[[avec; zeros(1,size(avec,2))] [a;nres]]; % compute the coefficient matrix
E=amat*amat′; % compute the outer product of the coefficients
U=[Ur ures]; % create the column space to be used in approximating the data matrix
[Ue, Se, Ve]=svd(E); % compute the SVD of E.
NewUr=U*Ue; % compute the new r principal left singular vectors of Ur
svals=sqrt(diag(Se)); % extract the singular values

The Frame Change Calculation routine 127 is where the Ur array is used to suppress clutter from the Test Frame 113 (Frame 3 in the Image Frame Buffer 110).

In Matlab, Ur=NewUr; cVector=[frame3pix, 1] where frame3pix is the image resized into a vector; temp1=Ur′*cVector; temp2=Ur*temp1; and csVector=cVector−temp2.

The array csVector is the GCS Array, and can be reshaped into a 2D image for viewing.

Referring still to FIG. 2B, in the Exceedance Detection routine 128, the GCS array is filtered by setting all pixels below a threshold to zero. The threshold is the maximum value between the parameter CfarMinThresh and a calculated CFAR threshold. CFAR stands for constant false alarm rate.

The calculated CFAR is generated by taking the mean and standard deviation of the GCS array and using the parameter CfarThreshFactor.

The parameters steps for Exceedance Detection in Matlab are in Table 4 and Equation 7.

TABLE 4
Parameters for Exceedance Detection

| Parameter Name | Setting | Units | Description |
|---|---|---|---|
| CfarMinThresh | 400 | DNs | Min value in the GCS Array to be |
| | | | detected as an exceedance |
| CfarThreshFactor | 7 | — | Scale factor for calculating |
| | | | CFAR threshold |

$$CFAR\_thresh = mean + ( stdDev * CfarThreshFactor ) \qquad ( 7 )$$

Pixels in the GCS array that are less than CFAR_thresh are set to zero. The remaining pixels are detected at Exceedance Detection routine 128 as Exceedance Pixels. They are clustered using the 2D Connected Components algorithm from the section relating to Pixel Clustering, routine 124, described above. Each cluster is saved in a list of Threat Locations (ThreatLoc list) for further processing in the clutter rejection block 140. Each cluster includes the Centroid, Pixel Area, Major Axis, Minor Axis and Axis Ratio, the latter of which is the ratio of Major and Minor Axis length, all of which are set forth hereinabove in Equations 4 and 5, above, relating to the Pixel Clustering routine 124.

### Step 3—Background Analysis.

There are two steps in analyzing the background. The first is to measure Optical Flow. Frame to frame changes for each pixel are measured, using the Farneback method of optical flow. There are three substeps followed to create flow vector maps. The other Step is background segmentation using the YOLOv5 (“You Only Look Once”) CNN algorithm.

### Creating Flow Vector Maps—Optical Flow

Flow vector maps are structures with arrays that have the values of row and column flow for each pixel, matching the image array size (1200 row by 1920 column). The row and column flow values can be visualized as magnitude flow vector map. In one embodiment, flow will be higher on edges and features with varying intensity. Uniform features, like the sky or road, will have low flow values.

FIG. 2C refers to the Background Analysis block 130, which involves measuring frame to frame changes for each pixel using the Farneback method of optical flow. In one embodiment, there are four routines followed to create flow vector maps. It is noted that the Background Analysis Block 130 runs in parallel to Exceedance Detection Block 120. Background Analysis Block 130 also influences Clutter Rejection Block 140, Threat Isolation Block 150 (described below) and where Flow Vectors Per Frame are updated prior to the Detection Frame Buffer, 160.

The Optical Flow pipeline may include four routines. The first of these is Downscale image, step 131. Downscaling an image runs the image through the pipeline faster. Referring to FIG. 2A, the Current Test Frame 113 (Frame 3) and Previous frame 112 (Frame −1) are taken from the frame buffer and scaled to 0.5 size, with nearest neighbor interpolation.

Contrast Enhancement 132 is the second routine of the Optical Flow pipeline where Flow is calculated on downscaled frames −1 (112) and test frame, 113, from the Image Frame Buffer 110 in FIG. 2A. Both images have their contrast enhanced using a Plateau Equalization function and the parameter plateauFraction. This function makes a count of the number of pixels of the plateau, where plateauCount=plateauFunction=(plateauFraction*pixels in image).

Then the algorithm generates a histogram of all intensity values in the image, ranging from 0 to the maximum value (65535). Any value in the histogram that is greater than plateauCount is set to plateauCount. The next step is to make a cumulative distribution function (cdf), with each value equal to the sum of the current value and previous value. This is normalized by the number of bins and maximum value (65535). This becomes a look-up-table (LUT) that can be applied to the current image using a 1-D interpolation function to rescale all the values and enhance contrast.

In FOGHAT data, most images fall within around 30000-40000 DNs, with the sun ranging as high as 65535 in some cases. Using Plateau Equalization gives the Cumulative Histograms different shapes, changing contrast adjustment. A value of 1 for Plateau results in maximum contrast change in the middle range of values. It does not apply any cut-off to the image histogram. In testing, it was determined that a plateauFraction value of 0.0005 was sufficient to have high contrast without saturating on details. In one embodiment, saturation in optical flow is avoided since that causes portions of images to have no pixel flow at all.

The Pixel Flow Calculations routine, 133 calculates Pixel Flow with the Farneback Method using dense optical flow. The Farneback algorithm generates an image pyramid where each level has a lower resolution compared to the previous level. Flow is tracked between the levels, beginning in the lowest resolution level and continuing until convergence. The point locations detected at a given level are propagated as key points for the subsequent level. In this way, the algorithm refines the tracking with each level. Pixel flow is the member of pixels (or fractions of pixels) that an object has moved from one frame to the next. It is measured in the X and Y directions, so it can display vectors. The X and Y flow values are used to adjust launch flashes across multiple frames, so any motion is removed and a proper time series spectrum can be measured. Pixel flow finds patterns of intensity differences in consecutive frames and measures the distance they moved. High brightness and good contrast are needed for good flow measurements. Uniformly bright areas are no better than uniformly dark areas because there is no contrast, so there is no way to determine changes in intensity.

Magnitude of the flow depends on the motion, not the brightness. The quality of the flow measurement is improved when there is a bright object or areas with good contrast. The actual magnitude of pixel flow for a video is on a moving car depends which part of the image is being considered. The sides will have higher flow than the center of the image, and the hood of the camera car will have low flow because it does not move relative to the camera.

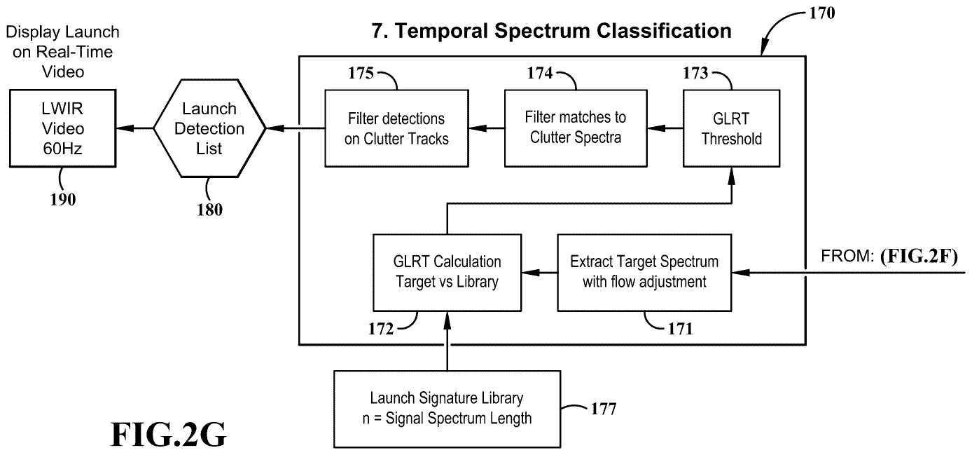

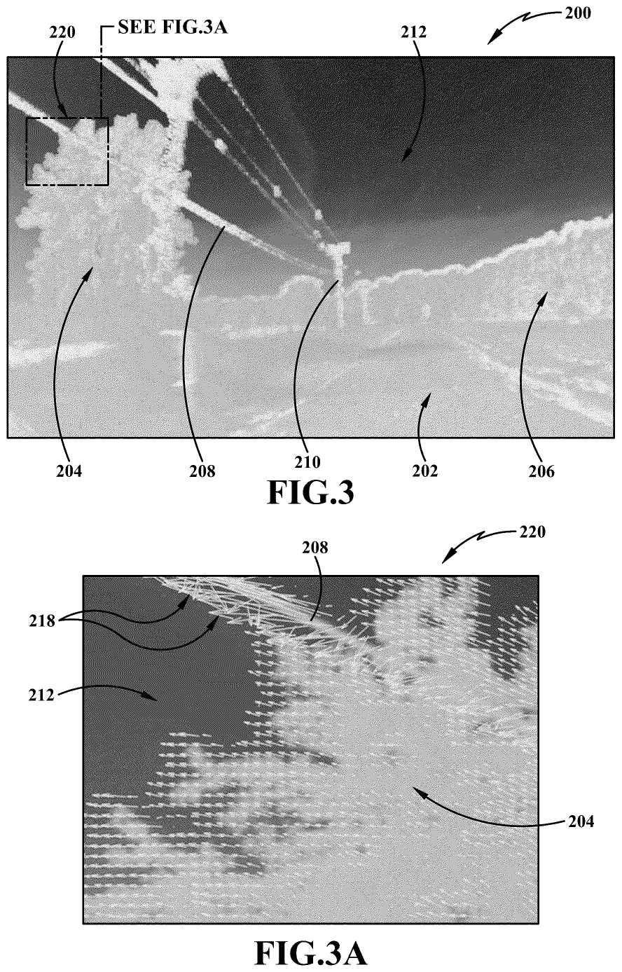

The Create Flow Vector Maps routine 134 in FIG. 2C produces vector maps that are structures with arrays having the values of row and column flow for each pixel matching the image array size (1200 row by 1920 column). The row and column flow values can be visualized as magnitude flow vector maps (see FIGS. 3 and 3A). Note that flow is higher on edges and features with varying intensity. Uniform features, like the sky or road, will have low flow values.

Pixel Flow maps or arrays are saved in a structure block, starting 9 frames before the current frame to be analyzed. This allows for the pre-launch signal to be adjusted in Threat Isolation block 150. Flow is measured in the X and Y directions and saved in floating point to retain fractional pixel values.

The function for optical flow is from OpenCV (cv.FarnebackOpticalFlow), made into a Mex file for Matlab. The inputs are shown in Table 5 below.

TABLE 5
Parameters for Optical Flow

| Parameter Name | Setting | Units | Description |
|---|---|---|---|
| flowFbWindowSize | 13 | Pixels | Farneback flow window kernel size to smooth out |
| | | | noise. |
| flowFbPolyN | 5 | Pixels | Farneback Flow neighborhood size to find polynomial |
| | | | expansion between pixels |
| flowFbPolySigma | 1.5 | Pixels | Standard deviation of the gaussian that is for |
| | | | derivatives to be smooth as the basis of the polynomial |
| | | | expansion. |
| plateauFraction | 0.0005 | Pixels | Fraction to determine the bin plateau |

### YOLO Background Segmentation

YOLOv5 is a model in the “You Only Look Once” (YOLO) family of computer vision models, which is designed for real-time object detection. It can identify and locate objects within images or video frames quickly and accurately. YOLOv5 is built on the PyTorch framework.

Setting up and using YOLOv5 involves several steps starting with setting up the environment. To install dependencies, Python and necessary libraries like PyTorch are required. A virtual environment can manage dependencies. A YOLOv5 repository may be cloned by Downloading the YOLOv5 code from its GitHub repository. A dataset may be prepared by collecting images containing objects to be detected and annotating the collected images. The objects in images may be labelled using annotation tools like Label Img or VIA. Annotations may be saved in YOLO format. YOLOv5 may be configured by choosing a YOLOv5 model variant (e.g., YOLOv5s, YOLOv5m, YOLOv5l, YOLOv5x) based on needs for speed and accuracy. Data may be configured by creating a data configuration file specifying paths to training and validation datasets. The model may be trained by first running a Training Script, which may be executed with a dataset and configuration files. This process involves multiple iterations where the model learns to detect objects. Training of the model may be monitored with tools like TensorBoard to visualize training progress and metrics. The model may be validated by running the model on a validation set to check its performance. Hyperparameters may be adjusted if necessary, followed by retraining the model to improve performance. The model's inference capabilities are determined by testing it on new images, for example using to detect objects in new images or videos. The results may be visualized, by displaying the detection results with bounding boxes and class labels. Finally, the model may be deployed by exporting the model: The trained model weights are saved, then the trained model weights may be saved then integrating the model into an application for real-time object detection.

YOLOv5 requires a trained YOLO network, with polygons drawn around each labeled object in training data. As disclosed herein, YOLOv5 has been trained originally using the MS COCO dataset, which is made up of 80 different classes of objects, but training on a custom dataset with FOGHAT classes is done using a method called “transfer learning”. This retains most of the layers in the YOLO network and replaces only the new layers at the end that make predictions for the new classes.

### YOLOv5 Training

For FOGHAT, YOLOv5 was trained with the following classes, selected to cover many of the common background objects encountered in urban and rural areas: 1: Car; 2: Truck; 3: Trailer_Truck; 4: Bus; 5: Tree; 6: Road; 7: Power_Line; 8: Building; 9: Obstacle; 10: Fence; 11: Pole; 12: Traffic_Signal; 13: Traffic_Sign; 14: Dismount; 15: Fire; 16: Motorcycle; 17: Bicycle; 18: Cloud; 19: Rough_Ground; 20: Sun; 21: Bush; 22: Mountain; 23: Bridge.

Training images are 8-bit grayscale jpegs made by running Plateau Equalization on the FOGHAT raw data and converting the results to 8-bit. This can be done in Python using a script like ModifiedOpenLabeling github.com/ivangrov/ModifiedOpenLabelling. Another method is to use the website makesense.com or the Matlab ImageLabeler.

These programs will export in a MS-COCO JSON format, but to do transfer learning, that exported file needs to be separated into individual YOLOv5 label files (.txt) with the following format: one row per object; each row is class x_center y_center width height format; box coordinates must be in normalized xywh format (from 0-1). If the boxes are in pixels, divide x_center and width by image width, and y_center and height by image height and class numbers are zero-indexed (start from 0).

To make individual YOLOv5 files, the Python script JSON2YOLO-master was used. Exemplary steps include: run Plateau Equalization and export frames as 8-bit jpegs in Matlab/ImageJ; make polygons in Makesense or ImageLabeler in Matlab. Export the JSON in the COCO JSON format. “Example: coco.json.” To put the COCO JSON into YOLOv5 format, there is a function in Python GitHub—ultralytics/JSON2YOLO: Convert JSON annotations into YOLO format; download and put in subfolder with YOLOv5 (E:\YOLO_V5\JSON2YOLO-master\JSON2YOLO-master); open the command window in that subfolder. Next, a user runs pip install—trusted-host pypi.org—trusted-host files.pythonhosted.org -r requirements.txt. The next step may be to make folders for COCO JSON file in same folder level as the folder with JOSN2YOLO-master (See figure below)???. And copy the COCO JSON file in such folder. Finally, run python general_json2yolo.py This makes “new_dir” with labels for coco.

To run the training, a .yaml configuration file should be made, containing the dataset root directory path and relative paths to image directories for training, validation and images, (or *.txt files with image paths) and the list of class names by number. The text below is in the .yaml file for FOGHAT training (FOGHAT_IR-seg_full.yaml). Note that numbering starts at 0 for the .yaml files.

| | |
|---|---|
| # | YOLOv5 YAML |
| # | Custom FOGHAT data by BAE Systems for segmentation training |
| # | Example usage: python segment/train.py --data FOGHAT_IR-seg.yaml |
| # | parent |
| # | ├ yolov5-master |
| # | └ datasets |
| # | └ FOGHAT ← images and labels here |

Training, validation and test sets (#Train/val/test sets) are found at 1) dir: path/to/imgs, 2) file: path/to/imgs.txt, or 3) list: [path/to/imgs1, path/to/imgs2, . . . ]; path: . . . /datasets/FOGHAT_Full #dataset root dir; train: images/train #train images (relative to ‘path’); val: images/val #val images (relative to ‘path’); test: #test images (optional). The classes of training images (and their number) may include or be determined by, #Classes; names; 0: Car; 1: Truck; 2: Trailer_Truck; 3: Bus; 4: Tree; 5: Road; 6: Power_Line; 7: Building; 8: Obstacle; 9: Fence; 10: Pole; 11: Traffic_Signal; 12: Traffic_Sign; 13: Dismount; 14: Fire; 15: Motorcycle; 16: Bicycle; 17: Clouds; 18: Rough_Ground; 19: Sun; 20: Bush; 21: Mountain; 22: Bridge.

Training data was input into a “datasets” folder that is next to the main yolov5 folder. The process then copied the labels from “new_dir” into the labels folder, into both the “train” and “val” subfolders.

Training was done in python while in the YOLOv5 master directory command window with the following command: python segment/train.py—data FOGHAT_IR-seg_full.yaml—weights yolov5s-seg.pt

This created a trained weights file called best.pt in the “runs” folder. Each training run makes a new folder in “runs”. The best.pt was copied out into the YOLOv5 master directory and renamed to best_SegTest_Y5.pt. This file can be tested in Python with a command such as below. Then change the source file to an avi file to run on a full video.

In order to use YOLOv5 in Matlab and C++, it was exported as an Onnx file. This was done with the Python command. The resulting file name is best_SegTest_Y5.onnx.

The Onnx file was loaded into Matlab for testing using the commands below.

cd E:\FOGHAT_ATGM\YOLO_Onnx_Files
modelname = ‘E:\FOGHAT_ATGM\YOLO_Onnx_Files\best_SegTest_Y5.onnx’
YOLOv5_Network_FOGHAT_Segment = importNetworkFromONNX(modelname);

The above steps produce a trained YOLO network, at item 135.

Within the YOLO Background Segmentation pipeline 3b, routine 137 is YOLOv5 Prediction and NMS (non-maximum suppression). Once the YOLOv5 Onnx file is loaded into Matlab, it can then be incorporated into the processing code to run prediction on a frame. Where C++ is used, the Onnx file can be converted into TensorRT to run faster.

In one embodiment, the Matlab command to run prediction on a frame was:

$$[ YOLO\_Output , MaskSet ] = predict ( YOLOv5\_network , Sharp\_IM \_YOLO )$$

This produced two files, YOLO_Output and MaskSet. YOLO_Output is [1, 25200, 60], where 25200 is the number of predictions with all anchors and 60 output results. The 60 output results include 23 classes, 5 points of localization information (x, y, w, h), IOU confidence score, and the last 32 are the mask weighting coefficients. MaskSet is [160, 160, 32], holding each of the 32 mask images. This is a downscaled version of the original 640×640 image. YOLOv5 uses a method inspired by YOLOACT, which uses activation masks (heat maps) generated during the CNN processing. There are 32 outputs from YOLO. Each detection has a weight output for each of the masks, so the YOLO output includes these values after the class results. Each mask is multiplied by the weights and summed to make the final mask.

### YOLOv5 Non-Maximal Suppression (NMS)

After the YOLO_Output array is generated, it is run through different steps to pick the best bounding boxes. The first step is find all predictions that have an IOU (intersection of union) confidence score that is equal to or higher than the parameter, YOLO_IOU_Threshold. This is a score related to how well the bounding boxes align with the training set boxes. Note that YOLO still works with bounding boxes even when it is trained with polygons around ground truth. The polygons are used in the segmentation pathway of Protonet.

After the filtering step, the remaining predictions have their dimensions squeezed down into a array with size [filtered predictions, 60], removing the singleton dimension. This array in Matlab is called AllDets YOLO_filt.

When scoring the classes, the first step is to make class arrays. The classes come after the first five values in AllDetsYOLO_filt. Additionally, the class results for all vehicles are combined into another array. This is because some vehicles may split their scores between the different vehicle classes, but each individual score may be low. In FOGHAT, the goal is to find any vehicle that could make clutter from reflections, not necessarily to classify them perfectly. Some trucks at long range may look like cars and pickup trucks often match to cars and trucks. The determination of whether a target is a vehicle and, if so, what kind of vehicle involves the following code:

classes = 32
class_results = AllDetsYOLO_filt(:,6:classes+5); %%% classes come after the first 5
class_results_veh = AllDetsYOLO_filt(:,6:9); %%% only the vehicles
class_results_veh_sum = sum(class_results_veh,2); %%% sum up the vehicles scores
- this is because a semi truck may have low scores in all four classes.

The next step is to find the highest score and class for each prediction. The matlab function call for this step is shown below.

$$[ Score , classnum ] = max ( class\_results , [ ] , 2 ) ;$$

These scores are then used to filter AllDetsYOLO_filt further. The indices for scores that pass the parameter YOLO_Class_Threshold or that have a summed vehicle score that pass that threshold are saved back into AllDetsYOLO_filt while the rest are excised. These indices are in the array Good_Det_YOLO, and are used to filter the scores and classes so they can be put into their own arrays.

Good_Det_YOLO = find(Score >= YOLO_Class_Threshold | class_results_veh_sum >=
YOLO_Class_Threshold);
AllDetsYOLO_filt = AllDetsYOLO_filt(Good_Det_YOLO,:);
boxresults = AllDetsYOLO_filt(:,1:4);
classnum_good = classnum(Good_Det_YOLO);
Score_good = Score(Good_Det_YOLO);

Now that the predictions are filtered, the bounding boxes are changed so that they are in a format with the first two values are the upper left corner of the box and not the centroid. This is necessary for Matlab to use polygon-based functions for non-maximal-suppression (NMS). The NMS function used in Matlab is called selectStrongestBboxMulticlass. This function takes in the filtered boxes, scores and classes along with the parameter, YOLO_OverlapThreshold.

| | |
|---|---|
| [selectedBbox_dets,Score_final,classnum_final,det_inds_final] | = |

selectStrongestBboxMulticlass(boxresults,Score_good,classnum_good,‘OverlapThresh
old’,YOLO_OverlapThreshold);

This function operates by looping through each class and finding those that overlap within the YOLO_OverlapThreshold value, a measure of intersection of union (IOU). The IOU score of two polygons is measured as the intersected area divided by the sum of the two polygons.

If there are two overlapping bounding boxes of the same class, the one with the highest Score is retained and the other is removed. The process loops through all bounding boxes, eliminating redundancies. The output from the function is a filtered set of bounding boxes, classes, scores and indices (det_inds_final).

Further in FIG. 2C, in routine 138 it is seen that YOLOv5 supports instance segmentation, which involves identifying and segmenting individual objects within an image. This is more advanced than simple object detection, as it provides a mask for each detected object, outlining its exact shape. In YOLOv5, instance segmentation is achieved by combining the detection heads with a segmentation head, often referred to as ProtoNet. This architecture allows the model to generate masks for each detected object, ensuring that the segmentation masks are clipped within the detected bounding boxes. The process involves: Object Detection that identifies and localizes objects within an image using bounding boxes, and Mask Generation, that creates a mask for each detected object, which outlines the object's shape within the bounding box.

The input image is scaled to 640×640, (8-bit) as the network is trained using yolov5s (small). It is possible to use higher resolution with other versions of the base YOLOv5 network. Downscaling was done using nearest neighbor interpolation and no letterboxing. The reason for this was that letterboxing reduced the resolution of the resulting segmentation masks and did not improve prediction.

In routine 138, YOLOv5 Instance Segmentation Masking, the array of indices in det_inds_final is used to go back to filter the AllDets YOLO_filt array and extract the segmentation mask weights for each of the bounding boxes. These are always the last 32 values of AllDetsYOLO_filt. The 32 masks for each bounding box detection are summed, making a single masked image of 160×160 (the mask size is 0.25 of the input image size). This masked image has all pixels outside the bounding box (downscaled to 0.25 size) set to 0, and all values less than YOLO_Mask_Threshold also set to 0. The rest of the pixels are set to 1. The result is a mask for each detection that only has pixels for that detection.

The bounding boxes and masks are rescaled to the original image size of the LWIR camera (1200×1920) so they can be used for filter detections. Masks must have a number of pixels on target greater than or equal to the parameter YOLOminArea or else they are not used in filtering detections. In an exemplary embodiment, trees and buildings must be 5× larger than YOLOminArea to be used. Some class masks are also removed from processing, Road, Mountains and Rough Ground, as launches can occur on them. The original image with bounding boxes and masks is shown below in FIG. 18. Output videos from the C++ code have the masks and boxes for reference purposes.

TABLE 6
Parameters for YOLOv5

| Parameter Name | Setting | Units | Description |
|---|---|---|---|
| YOLO_IOU_Threshold | 0.10 | — | Minimum threshold for how well a bounding box |
| | | | matched training data bounding boxes (size and |
| | | | position) |
| YOLO_Class_Threshold | 0.75 | — | Minimum threshold for class score |
| YOLO_OverlapThreshold | 0.25 | — | Minimum threshold for overlap in IOU score during |
| | | | NMS |
| YOLO_Mask_Threshold | 0.25 | — | Minimum threshold value for YOLO masks |
| YOLOminArea | 8 | pixels | Min number of pixels for a mask to be used in filtering |
| | | | detections |
| YOLO_Max_Area_Ratio | 0.25 | — | Maximum ratio of the detection to the YOLO |
| | | | background mask pixels. Large detections on similar |
| | | | sized objects will still be retained. Small detections on |
| | | | large objects will be filtered out. |
| YOLO_Seg_MinDistIn | 1 | pixels | Number of pixels to erode from the mask before |
| | | | checking to see if a launch is on a mask. |

While YOLOv5 was used hereinabove, other software systems may perform similar functions of image or object detection such as newer versions of YOLO like versions 6, 7, and 8, YOLOX, Faster R—CNN and EfficientNet.

FIG. 2D depicts the Clutter Rejection block 140. By way of overview, this block takes cluster shape information from earlier pipelines such as the Anomalous Clutter Tracking Pipeline, 121 and the Exceedance Detection block, pipeline 122, and filters out exceedances by shape and clutter tracks, in routine 141. It then examines each remaining detection and matches them to a launch signature library 177 of images from launches and backgrounds using a Fastnet CNN 147 to further reject exceedances from clutter at the Filter Clutter Exceedances routine 144.

In further detail, and referring to FIG. 2D, the first step of the Clutter Rejection block 140, is the Filter Exceedances by Shape and Clutter Tracks routine 141. Exceedance detections in the ThreatLoc list are filtered using Area and Axis Ratio thresholds (see parameters in Table 5) to reject shapes that are too large or too long. Too large or too long means that the exceedance cluster has more pixels than the MaxClusterSize parameter of has an axis ratio greater than cmMaxAxisRatioS or cmMaxAxisRatio. Exceedances that are within a threshold pixel distance (clutterMinTrackDist) from the clutter tracked by the clutter tracker routine 125 (which uses a Kalman Filter) (FIG. 2B) that are “old” in terms of track age (clutterMinTrackAge) are also filtered out. The distance is measured between each exceedance and Clutter Tracks using Equation 8 below, scaling the threshold based on a boundary of the detection.

$$Distance to Clutter Track = \sqrt{{( {Row}_{track} - {Row}_{exceed} )}^{2} + {( {Col}_{track} - {Col}_{exceed} )}^{2}} - ( {Major}_{Axis} * 0.5 ) \qquad ( 8 )$$

The Matlab parameters for Exceedance Filtering are presented in Table 7.

TABLE 7
Parameters for Exceedance Filtering

| Parameter Name | Setting | Units | Description |
|---|---|---|---|
| cmAreaMaxCutoff | 100 | pixels | If cluster area is equal or less, use cmMaxAxisRatioS |
| | | | for the axis ratio threshold, otherwise use |
| | | | cmMaxAxisRatioL |
| cmMaxAxisRatioS | 3.5 | — | Maximum threshold for axis ratio for small |
| | | | exceedances |
| cmMaxAxisRatioL | 1.5 | — | Maximum threshold for axis ratio for large |
| | | | exceedances |
| MinClusterSize | 2 | pixels | Minimum area in pixels for an exceedance to pass |
| MaxClusterSize | 1000 | pixels | Maximum area in pixels for an exceedance to pass |
| clutterMinTrackDist | 20 | pixels | Minimum distance in pixels between an exceedance |
| | | | and a clutter track in order to filter the exceedance |
| clutterMinTrackAge | 10 | frames | Minimum age of a clutter track before it can be |
| | | | compared to an exceedance |

In Routine 142, image chips are created from exceedances. Proceeding according to the Threat Location (ThreatLoc) list, image chips are cut out from the Test Frame 113 using centroid pixel coordinates and a background radius parameter (fastnetBkgRadius) to determine the size and location of the image chips, scaled by the cluster Major Axis. The calculation in Equation 9 is limited to double the value of fastnetBkgRadius.

$$Box radius ( Row and Column ) = round ( fastnetBkgRadius + Cluster Major\_Axis * 2 ) \qquad ( 9 )$$

The image chips produced in routine 142 are stretched using a standard deviation stretch. There are two possible cases. The first case occurs if there is more than one exceedance in the chip area or if the detection intensity is less than the maximum intensity of the background pixels. This is typical of most clutter. The algorithm calculates mean and standard deviation (StdDev), and makes new intensity boundaries by adding and subtracting 3*StdDev from the mean. The image is then normalized based on those new values. The minimum is limited to 0 and maximum limited to the maximum value of the image. The image is normalized using Equation 10 to make a stretched image.

$$Normalized\_img = ( img - minimum ) / ( maximum - minimum ) \qquad ( 10 )$$

The second case occurs when the detection is the brightest object in the chip and there are no other exceedance detections in the chip. This is typical of most launches unless there are hot objects in the foreground. In this case, a new chip radius is calculated, smallboxRad, which is ⅓ the size of fastnetBkgRadius. A small chip is cut from the center of image chip using smallboxRad and rescaled to the original chip size (nearest neighbor interpolation). A new maximum value and maximum for the stretch is calculated from the maximum and minimum value of the small box (minval_small, maxval_small) and fastnetSmallBoxStretchFraction. These are used in Equation 11 to make the normalized image.

$$OffsetDiff = ( maxval\_small - minval\_small ) * fastnetSmallBoxStretchFraction ; \qquad ( 11 )$$

$$minimum = minval\_small + OffsetDiff ;$$

$$maximum = maxval\_small - OffsetDiff ;$$

TABLE 8
Parameters for Fastnet Image Chips

| Parameter Name | Setting | Units | Description |
|---|---|---|---|
| fastnetSmallBoxStretchFraction | 0.10 | — | Used to calculate |
| | | | max and min for |
| | | | small boxes |

For the Fastnet CNN Chip Classification routine 143, the remaining exceedances in the ThreatLoc list are examined in the current Test Frame 113 to see if they are common clutter types. A trained Fastnet CNN 147, may be used for this routine. Details on CNNs are described above. Use of a CNN is beneficial as camera motion can make exceedances appear in the GCS routine 129 from any bright object or edge with high contrast that moves from frame to frame.

Separate from, but connected to, the Clutter Rejection block 140, is a representation of a Fastnet CNN 147 for FOGHAT, or “Fastnet.” Fastnet CNN 147 is a flexible design that can be trained to use grayscale images for classification. For FOGHAT, the Fastnet CNN 147 was trained with launch image chips as well as common clutter types. Some examples of training images include bright spots on a dark background for launches; cars, city scenes, power lines, trees, windows, etc., (not shown). The Fastnet network is designed with five convolution layers, taking in 64×64 pixel grayscale images. Fastnet is fed blocks of image chips made from all of the exceedances, formed into a 4D array (64×64×1×Num chips) and outputs a list of scores (0-1) and class names for each chip.

The fourth routine of the Clutter Rejection block 140 is the Filter Clutter Exceedances routine 144, using a CNN. In this routine, exceedances with a class match lower than the threshold (fastnetMinThresh) are filtered out from the ThreatLoc list

Filtering Detections with Background Segment Masks, routine 145, compares detections that have passed the other tests to compared to the YOLOv5 instance segmentation masks from Step 3b (FIG. 2C). Each detection centroid is compared to the masks, after applying an erode function with the number of pixels equal to the parameter YOLO_Seg_MinDistin in Table 6. If the detection falls upon a mask and the area ratio is greater than or equal to YOLO_Max_Area_Ratio, the detection passes through. The relevant equation is:

area ratio=detection cluster area in pixels/mask pixel area (scaled to full resolution)

Table 9 presents the MatLab parameters for the FastNet CNN.

TABLE 9
Parameters for Fastnet CNN in Matlab:

| Parameter Name | Setting | Units | Description |
|---|---|---|---|
| fastnetBkgRadius | 25 | pixels | Radius width/height around |
| | | | centroid for image chips |
| fastnetMinThresh | 0.50 | — | Minimum CNN class score |

### Sky Filter

Further, as an optional part of routine 145, an optional filter is run on any remaining detections to check if they are in the sky. This function creates a vector in the column of the detection centroid, with all rows. This vector, Testvec, is run through a 1D ordered filter, 3 pixels wide, that calculates the max and min values of the 3-pixel block and subtracts Max-Min. This creates the vector, Edgevec, that has enhanced values at edges. The idea is to find the first large peak in the vector as it is likely to be the border between land and sky. The pixels around the detection (5 pixels above and below) in Edgevec are set to 0 to avoid using a launch for an edge.

The first peak in Edgevec greater than the parameter horizon_edgethresh is chosen as the “sky” and saved in the variable MinEdgePeak. If this peak occurs above the launch, possibly due to clouds, or if there are no peaks detected, there is a default row parameter, sky_row, that is used instead. The intensity is analyzed above and below the launch in Testvec with the following code:

upperSection = TestVec(1:MinEdgePeak);
lowerSection = TestVec(MinEdgePeak+1:nrows);
MedUpper = median(upperSection);
MinLower = min(lowerSection)*LowerFrameScaleFactor;
Abovepix = TestVec(minrow_edge);
Belowpix = TestVec(maxrow_edge);

The detection is filtered if Abovepix<MinLower and Belowpix<MinLower and centroid_row<MinEdgePeak.

The Threat Isolation Block 150 is depicted in FIG. 2E. Exceedances in the ThreatLoc list are re-examined by making a window around the detected pixels and another window for the local background pixels, without the detected pixels. These windows are used to extract flow vectors from the current frame and subsequent frames of the time series. The windows are also used to calculate brightness (intensity difference between detection and background) and SNR, both used for local clutter suppression (LCS).

MatLab Parameters for Threat Isolation are found in Table 10.

TABLE 10

| Parameter Name | Setting | Units | Description |
|---|---|---|---|
| LcsWindowSize | 3 | — | Scale factor for Background window |
| | | | size relative to Target |
| CfarMinThresh | 400 | DNs | Min Brightness to be detected as |
| | | | an exceedance (same parameter |
| | | | as in Step 2) |
| MinCfar2Thresh | 3.5 | — | SNR threshold for LCS |
| Cfar2Risk | 0.01 | — | Risk used in CFAR threshold |
| | | | calculation |
| Cfar2PFA | 0.1 | — | Probability of False Alarm for |
| | | | CFAR threshold calculation |

Further referring to FIG. 2E, the first routine of the Threat Isolation block 150 is the Detection and Background Windows routine 151. Square windows are made around the centroid of the exceedance detection cluster. The width and height of the Target window around the exceedance is equal to the Major Axis length of the exceedance cluster. The Background window is scaled up from the target window using the parameter LcsWindowSize, and has the target window masked out.

The next routine is the Extract Flow Vectors for Windows routine 152, where the mean flow vectors from the Test Frame are calculated within the Target window and saved in the ThreatLoc list.

Further, in FIG. 2E, the Determine Brightness Threshold routine 153 calculates brightness from the maximum intensity of pixels within the Target window, which is compared to the mean of the Background window pixels, calculated in Detection and Background Windows routine 151. The difference is the Brightness value for that exceedance. If the Brightness value is less than the exceedance threshold (CfarMinThresh from Step 2) the exceedance is filtered out.

The final step of the Threat Isolation block 150 is Local Clutter Suppression (LCS) routine 154, further depicted in FIG. 2E. The LCS routine calculates SNR from the Target and Background windows. SNR is calculated for each pixel in the Target window. If the SNR is less than the threshold (maximum value between MinCfar2Thresh or CFAR calculation with Cfar2Risk and Cfar2PFA) for all Target window pixels, the exceedance is filtered out. Equation 12 calculates SNR.

$$SNR = ( T - Bmean ) \hat{} 2 / Bvar \qquad ( 12 )$$

$$T = Target pixel , Bmean = Background Window Mean ,$$

$$Bvar = Background Window variance$$

Referring to FIG. 2F, Step 6 of the Algorithm involves inputs to the Detection Frame Buffer block 160. Image processing from the Threat Isolation Block passes to the Exceedance Detection list 155, which stores exceedances, and inputs images to Exceedance Proposal Coordinates 161, where exceedance proposal coordinates with flow are developed. The Detection Frame Buffer block 160 requires an exceedance detection (from exceedance detection list 155) to start the buffer at which time the buffer has pixel coordinates for a particular frame, such as Detection Frame 163, and the pixel flow (X and Y directions) from the previous frame, such as detection frame 163A. The pixel flow values (X and Y) for the nine frames before the current frame (where the center frame is frame 9) are saved in a data structure and later used in this function with the detection pixel coordinates to measure the pixel flow in those frames for the current detection. Upon obtaining a detection in one frame, it is possible to go back in time (to earlier frames) to see how the pixels were moving in past frames and remove the motion. When an exceedance is detected and passes all preceding clutter rejection blocks and routines, it is added to the Time Series Buffer 162 of Detection Frame Buffer block 160.

TABLE 11
MatLab Parameters for Detection Frame Buffer

| Parameter Name | Setting | Units | Description |
|---|---|---|---|
| sigTemplateLength | 9 | frames | Length of the frame buffer |
| centerFrame | 1 | frames | Determines the start frame |
| | | | of the buffer relative to |
| | | | the Test frame when the |
| | | | exceedance was detected. |
| | | | When set to 1, the buffer |
| | | | begins 1 frame before |
| | | | the Test Frame. |

The values for Flow in the X (ColFlow) and Y (RowFlow) direction are added for the first frame. As the Frame Buffer is updated with new frames, the Flow Vectors for those frames are added onto the RowFlow and ColFlow arrays. This way, each frame will have the correct flow vectors. Once all frame slots in the buffer have been filled, the Detection Frame Buffer for that exceedance is sent to Block 7, Temporal Spectrum Classification.

Table 12 presents MatLab parameters for temporal spectrum classification.

TABLE 12

| Parameter | | | |
|---|---|---|---|
| Name | Setting | Units | Description |
| GlrtThresh | 0.70 | — | Minimum threshold for GLRT score. |
| | | | If the GLRT score is equal or higher |
| | | | than this, it is a launch detection. |
| numPhaseShift | 1 | frames | Number of frames to phase |
| | | | shift during GLRT testing |

Referring to FIG. 2G, Block 7 is the Temporal Spectrum Classification block 170, which begins with the routine for target spectrum extraction 171 with flow adjustment. The exceedance proposal coordinates 161 from the Detection Frame Buffer block 160 has the initial exceedance coordinates from the first frame and the Flow Vectors from the Create Flow Vector Maps routine 133 (see FIG. 2C) for subsequent frames. The target spectrum is extracted from a Time Series buffer 162 of full-resolution image frames equal in size to the time series spectrum—The Frame Block Buffer (full resolution images filling a 3D buffer of size [rows, cols, sigTemplateLength]).

The routine for target spectrum extraction 171 is run using the target window centered on the exceedance centroid, now called the Detection Window. The Detection Window location is shifted in xy position for each frame in the buffer using the Rowflow and Colflow vectors.

The goal is to make all the frames align with the Test Frame in the buffer Frame 2, of the buffer when using the parameters from Table 9. The maximum value of the pixels in the aligned Detection Windows is extracted and used as the signal for each frame in the time series.

Further referring to FIG. 2G, the target spectrum is compared to known launch spectra in launch signature library 177 as discussed above, and common clutter spectra using the GLRT 172. Spectra that do not exceed a threshold value, such comparison being performed by routine 173 are filtered out at routine 174. Detections that are within a distance of clutterMinTrackDist of Clutter Tracks (from Step 2) are also filtered out, by routine 175 (Filter detections on clutter tracks). This distance is measured by Equation 8, with the Filter Exceedances by Shape and Clutter Tracks routine 141. The GLRT score for each library spectrum is calculated with Equation 13 below.

$$GLRT Match Score = \frac{{( {\sum }_{i = 1}^{Fr} Targ )}^{2}}{( {\sum }_{i = 1}^{Fr} Targ ) * ( {\sum }_{i = 1}^{Fr} Libspec )} \qquad ( 13 )$$

When calculating the GLRT score, three values are calculated for each library spectrum through phase shifting, adjusting the values in the X-axis (frames) and effectively making the spectrum peak slide forward and backward in time. When the target spectrum is tested against a library spectrum, the library spectrum is are phase shifted forwards and backwards by the parameter numPhaseShift. The standard value for numPhaseShift is 1, which means that a phase shift of −1, 0 and 1 frames. The target spectrum has GLRT measured against these three versions of the library spectrum, taking highest score out of the three. GLRT is measured against all spectra in the library, with phase shifts for each of them and the library spectrum with the highest score is the final match. This final GLRT score must pass the threshold GirtThresh in order to be saved in the Detection List 180. If the spectrum matches a launch with a high enough confidence after filtering detections on Clutter Tracks, routine 175, it is reported as a launch in the Detection List 180, where such launch may be displayed in real time on a video display, at block 190.

The Detection List includes Frame Number, Row and Column coordinates (Az/Alt with IMU data), Threat Type, GLRT Score and the Signature Spectrum. Threat Type is the number of the launch signature in the threat file, starting with 0.

FIG. 3 shows an LWIR image of a scene, 200, which includes several features including road 202, tree 204, forest 206, power lines 208, power pole 210, as well as sky 212. FIG. 3A shows flow vectors for an expanded region of FIG. 3. The brightest features in FIG. 3 have the highest (longest) flow vectors in FIG. 3A, 220. For example, the power lines 208 are the brightest features in FIG. 3A, so the corresponding flow vectors 218 are the longest. The sky 212 is black indicating no flow.

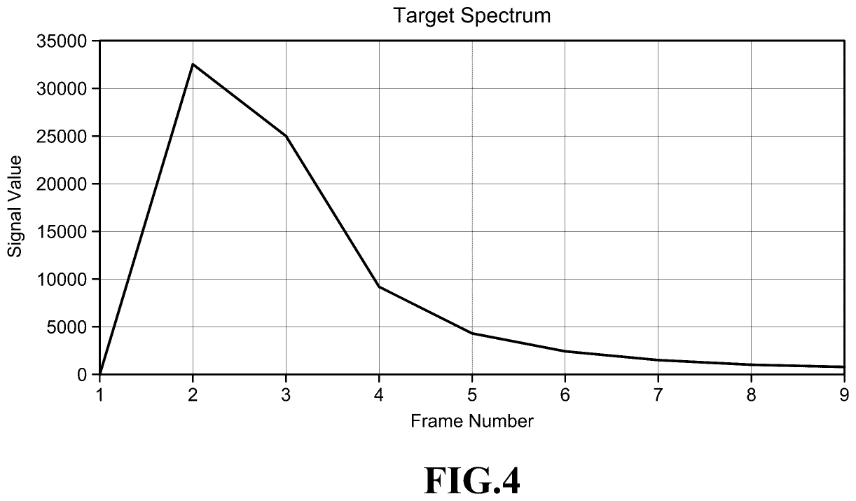

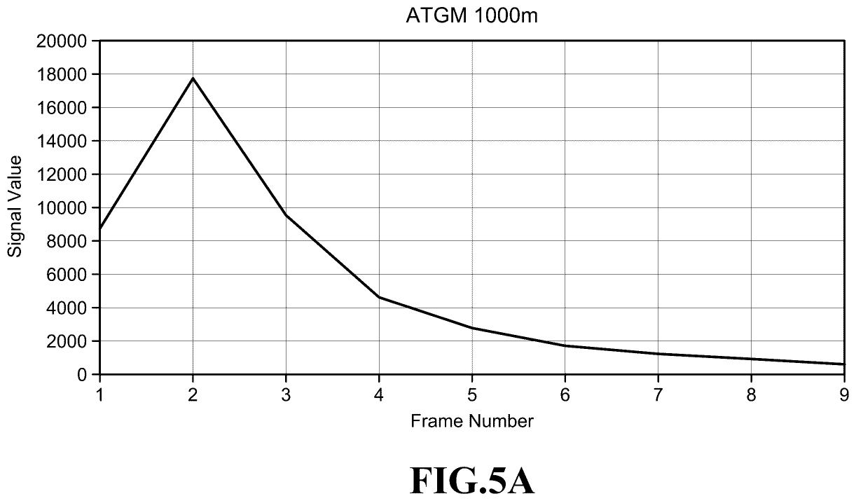

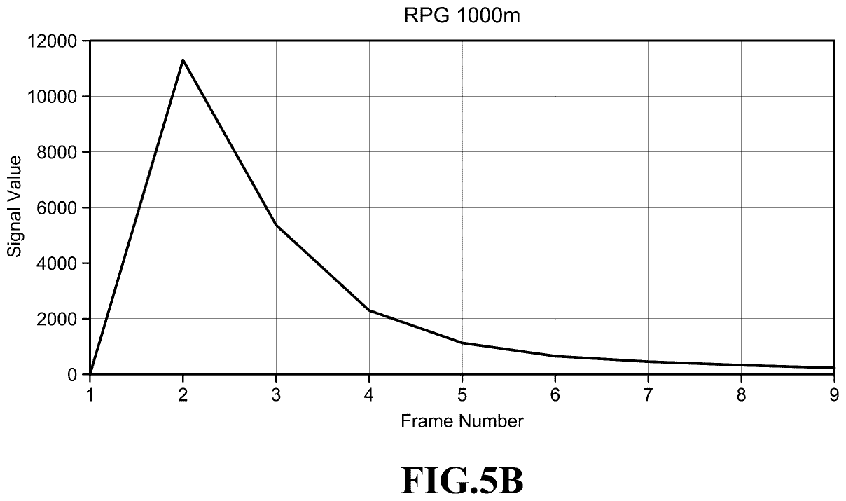

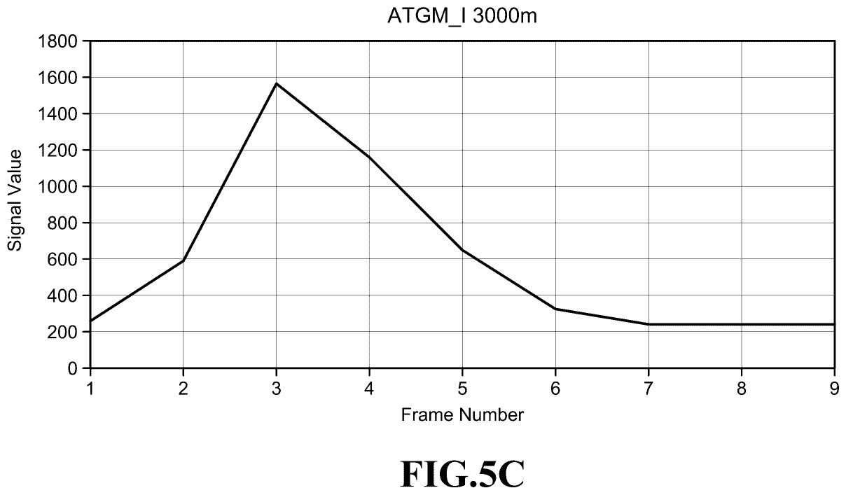

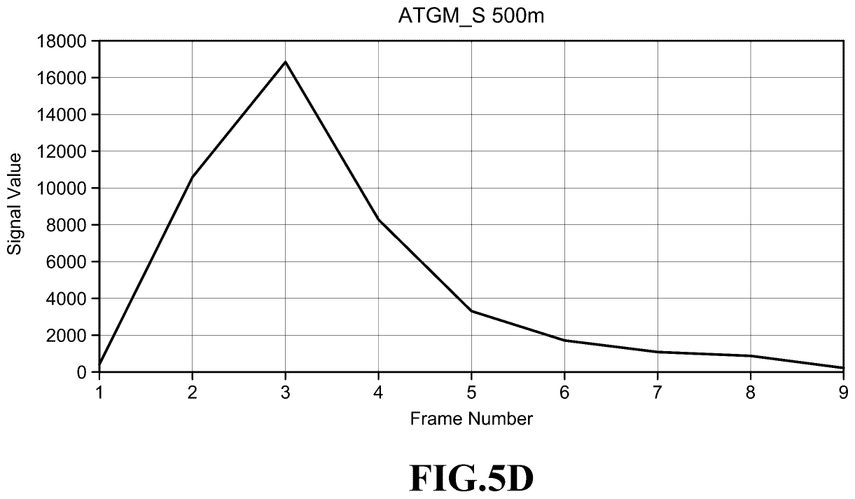

FIG. 4 shows an exemplary target detection spectrum of the launch of an unknown target, indicating that the exceedance was detected at frame 2, the highest signal value. FIGS. 5A-5D show exemplary known launch spectra from a library of such spectra. FIG. 5A is the launch spectrum of an ATGM at a range of 1000 meters; the exceedance was detected at frame 2. FIG. 5B is the launch spectrum of an RPG at a range of 1000 meters; the exceedance was detected at frame 2. FIG. 5C is the launch spectrum of an ATGM at a range of 3000 meters; the exceedance was detected at frame 3. FIG. 5D is the launch spectrum of an ATGM at a range of 500 meters; the exceedance was detected at frame 3.

Having described the process and algorithms utilized for ATR system 10 the generalized use thereof will now be discussed further. Specifically, the use of Fastnet CNN 147 allows for real-time processing of both daytime visual and LWIR video and/or images for target detection, identification, classification and tracking. While further using LWIR video at night the use of both types of detectors allow for a window based near field detector to be combined with a long-range infrared detector to detect, identify and track targets at a real-time or near real-time speed even from a moving vehicle including aircraft and or maritime vehicles.

The combination of pixel based long-range detectors and window based short-range detectors is increasingly important for military operations where situational awareness is critical but may be adapted for non-military applications as automated driving and/or security needs evolve. Other such applications may likewise benefit from the implementation of ATR system 10 and/or similar ATR systems utilizing a fast convolutional neural-network which may be trained and or retrained for ever-evolving targets and threats.

At its most basic, as discussed herein, ATR system 10 may simply utilize the features of LWIR and visual RGB detectors, or other sensors, along with machine trained Fastnet CNN 147 to compare and process single frames and groups of images from video detection to identify, classify, and track targets. ATR system 10 may do so utilizing heat maps approach involving use of rectify linear unit output as a third layer of the Fastnet CNN 147, allowing for more accurate and real-time results.

The system of the present disclosure may additionally include one or more sensors to sense or gather data pertaining to the surrounding environment or operation of the system. Some exemplary sensors capable of being electronically coupled with the system of the present disclosure (either directly connected to the system of the present disclosure or remotely connected thereto) may include but are not limited to: accelerometers sensing accelerations experienced during rotation, translation, velocity/speed, location traveled, elevation gained; gyroscopes sensing movements during angular orientation and/or rotation, and rotation; altimeters sensing barometric pressure, altitude change, terrain climbed, local pressure changes, submersion in liquid; impellers measuring the amount of fluid passing thereby; Global Positioning sensors sensing location, elevation, distance traveled, velocity/speed; audio sensors sensing local environmental sound levels, or voice detection; Photo/Light sensors sensing ambient light intensity, ambient, Day/night, UV exposure; TV/IR sensors sensing light wavelength; Temperature sensors sensing machine or motor temperature, ambient air temperature, and environmental temperature; and Moisture Sensors sensing surrounding moisture levels.

The system of the present disclosure may include wireless communication logic coupled to sensors on the system. The sensors gather data and provide the data to the wireless communication logic. Then, the wireless communication logic may transmit the data gathered from the sensors to a remote device. Thus, the wireless communication logic may be part of a broader communication system, in which one or several devices, assemblies, or systems of the present disclosure may be networked together to report alerts and, more generally, to be accessed and controlled remotely. Depending on the types of transceivers installed in the system of the present disclosure, the system may use a variety of protocols (e.g., Wi-Fi®, ZigBee®, MIWI, BLUETOOTH®) for communication. In one example, each of the devices, assemblies, or systems of the present disclosure may have its own IP address and may communicate directly with a router or gateway. This would typically be the case if the communication protocol is Wi-Fi®. (Wi-Fi® is a registered trademark of Wi-Fi Alliance of Austin, TX, USA; ZigBee® is a registered trademark of ZigBee Alliance of Davis, CA, USA; and BLUETOOTH® is a registered trademark of Bluetooth Sig, Inc. of Kirkland, WA, USA).

In another example, a point-to-point communication protocol like MiWi or ZigBee® is used. One or more of the system of the present disclosure may serve as a repeater, or the systems of the present disclosure may be connected together in a mesh network to relay signals from one system to the next. However, the individual system in this scheme typically would not have IP addresses of their own. Instead, one or more of the systems of the present disclosure communicates with a repeater that does have an IP address, or another type of address, identifier, or credential needed to communicate with an outside network. The repeater communicates with the router or gateway.

In either communication scheme, the router or gateway communicates with a communication network, such as the Internet, although in some embodiments, the communication network may be a private network that uses transmission control protocol/internet protocol (TCP/IP) and other common Internet protocols but does not interface with the broader Internet, or does so only selectively through a firewall.

As described herein, aspects of the present disclosure may include one or more electrical, pneumatic, hydraulic, or other similar secondary components and/or systems therein. The present disclosure is therefore contemplated and will be understood to include any necessary operational components thereof. For example, electrical components will be understood to include any suitable and necessary wiring, fuses, or the like for normal operation thereof. Similarly, any pneumatic systems provided may include any secondary or peripheral components such as air hoses, compressors, valves, meters, or the like. It will be further understood that any connections between various components not explicitly described herein may be made through any suitable means including mechanical fasteners, or more permanent attachment means, such as welding or the like. Alternatively, where feasible and/or desirable, various components of the present disclosure may be integrally formed as a single unit.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone may be utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments. As such, one aspect or embodiment of the present disclosure may be a computer program product including least one non-transitory computer readable storage medium in operative communication with a processor, the storage medium having instructions stored thereon that, when executed by the processor, implement a method or process described herein, wherein the instructions comprise the steps to perform the method(s) or process(es) detailed herein.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software, and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

While components of the present disclosure are described herein in relation to each other, it is possible for one of the components disclosed herein to include inventive subject matter, if claimed alone or used alone. In keeping with the above example, if the disclosed embodiments teach the features of components A and B, then there may be inventive subject matter in the combination of A and B, A alone, or B alone, unless otherwise stated herein.

As used herein in the specification and in the claims, the term “effecting” or a phrase or claim element beginning with the term “effecting” should be understood to mean to cause something to happen or to bring something about. For example, effecting an event to occur may be caused by actions of a first party even though a second party actually performed the event or had the event occur to the second party. Stated otherwise, effecting refers to one party giving another party the tools, objects, or resources to cause an event to occur. Thus, in this example a claim element of “effecting an event to occur” would mean that a first party is giving a second party the tools or resources needed for the second party to perform the event, however the affirmative single action is the responsibility of the first party to provide the tools or resources to cause said event to occur. In one example, a target is detected in the ROI of a video that is provided by a supplier of the sensor. This supplier would be the entity that is “effecting” the user of the system to perform the functions, actions, or steps detailed herein. Thus, a method could be accomplished by the supplier of the technology that effects a customer to capture, via at least one detector, a sequence of image frames that define a video depicting the ROI; effects the customer to process the video with at least one of a long range target detection (LRTD) pipeline, a long range motion detection (LRMD) pipeline, and a short range target detection (SRTD) pipeline to detect the at least one target in the video in or near the ROI; effects the customer to apply a convolutional neural network (CNN) to the video to identify and classify the at least one target therein; effects the customer to generate at least one frame detection list containing data about the at least one target; effects the customer to calculate persistence and shape consistency of the at least one target; and effects the customer to apply at least one multi-target Kalman filter to the at least one frame detection list to generate a track list including the at least one target, wherein the at least one target is tracked in response to detection in the video of the ROI, and effecting the at least one target to be tracked.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” “an exemplary embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” “an exemplary embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

To the extent that the present disclosure has utilized the term “invention” in various titles or sections of this specification, this term was included as required by the formatting requirements of word document submissions pursuant the guidelines/requirements of the United States Patent and Trademark Office and shall not, in any manner, be considered a disavowal of any subject matter.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed is:

1. A computer program product including one or more non-transitory machine-readable mediums encoded with instructions encoded thereon that when executed by one or more processors cause a process to be carried out for automated launch detection and tracking, the instructions comprising:
capture, via at least one detector, a sequence of image frames that depict a region of interest (ROI);
process the sequence of image frames with an anomalous clutter tracker (ACT) pipeline, to detect at least one launch in the sequence of image frames;
apply a machine learning technique to the sequence of image frames to classify the at least one launch therein;
generate at least one frame detection list containing data about the at least one launch; and
apply at least one clutter tracker filter to the at least one frame detection list to generate a detection list including the at least one launch, wherein the at least one launch is detected in response to a detection in a video of the ROI, and causing the at least one launch to be detected.

2. The computer program product of claim 1, the instructions further comprising:
process the sequence of image frames through an exceedance detection (ED) pipeline using a global clutter suppression (GCS) routine and an optical flow pipeline (OFP);
combine an output of the ACT pipeline with an output of the ED pipeline to enter a clutter rejection (CR) pipeline; and
generate a frame array from each of the ACT and ED pipelines.

3. The computer program product of claim 1, the instructions further comprising:
process raw image frames through a clutter rejection (CR) pipeline;
filter a set of image windows from the raw image frames in the CR pipeline; and
group the set of image windows into a batch and apply the machine learning technique to the batch to classify the at least one launch therein.

4. The computer program product of claim 3, the instructions further comprising:
determine and filter cluster exceedances;
create a batch of image chips from filtered cluster exceedances in the CR pipeline; and
create a batch of non-redundant image chips from the ACT and GCS pipelines.

5. The computer program product of claim 1, the instructions further comprising:
create detection and background windows;
extract flow vectors from the detection and background windows;
determine and apply a brightness threshold of a maximum intensity of pixels within the detection window to a mean intensity of pixels in the background window; and
locally suppress clutter based on a signal to noise ratio threshold based on a target pixel intensity, background spectrum, and background standard deviation.

6. The computer program product of claim 2, the instructions further comprising:
calculate initial flow vectors from the OFP, wherein the OFP comprises instructions to:
enhance contrast of a test frame image;
calculate pixel flow of the enhanced contrast test frame image; and
create flow vector maps based on pixel flow.

7. The computer program product of claim 1, the instructions further comprising:
extract a target spectrum with an updated flow adjustment;
compare a generalized likelihood ratio test (“GLRT”) calculation target to a library of stored exceedance images;
apply a GLRT threshold to the extracted target spectrum;
filter matches to clutter spectra based on GLRT spectra; and
filter detections on clutter tracks.

8. The computer program product of claim 1, wherein the instructions further comprise:
populate a launch detection list.

9. The computer program product of claim 1, wherein the instructions further comprise:
capture a video from at least two detectors, wherein a first director is a red green blue (RGB) video camera and a second detector is a long-wave infrared (LWIR) video camera.

10. The computer program product of claim 1, wherein the instructions further comprise:
detect a first target with a RGB video camera; and
detect a second target with LWIR video camera.

11. A method of automated launch detection and tracking, the method comprising:
capturing, via at least one detector, a sequence of image frames that define a video depicting a region of interest (ROI);
processing the sequence of image frames with an anomalous clutter tracker (ACT) pipeline, to detect at least one launch in the sequence of image frames;
applying a machine learning technique to the sequence of image frames to classify the at least one launch therein;
generating at least one frame detection list containing data about the at least one launch; and
applying at least one clutter tracker Kalman filter to the at least one frame detection list to generate a detection list including the at least one launch, wherein the at least one launch is detected in response to a detection in the video of the ROI, and causing the at least one launch to be detected.

12. The method of claim 11, further comprising:
processing the sequence of image frames through an exceedance detection (ED) pipeline using a global clutter suppression (GCS) routine; and an optical flow pipeline (OFP);
combining an output of the ACT pipeline with an output of the ED pipeline to enter a clutter rejection (CR) pipeline; and
generating a frame array from each of the ACT and ED pipelines.

13. The method of claim 11, further comprising:
processing raw image frames through a clutter rejection (CR) pipeline;
filtering a set of image windows from the raw image frames in the CR pipeline; and
grouping the set of image windows into a batch and applying the machine learning technique to the batch to classify the at least one launch therein.

14. The method of claim 11, further comprising:
determining and filtering cluster exceedances;
creating a batch of image chips from filtered cluster exceedances in the CR pipeline; and
creating a batch of non-redundant image chips from the ACT and GCS pipelines.

15. The method of claim 11, further comprising:
creating detection and background windows;
extracting flow vectors from the detection and background windows;
determining and applying a brightness threshold; and
locally suppressing clutter based on a signal to noise ratio threshold.

16. The method of claim 12, further comprising:
providing initial flow vectors from the OFP, wherein the OFP comprises instructions to:
enhance contrast of a test frame image;
calculate pixel flow of the test frame image; and
create flow vector maps based on pixel flow.

17. The method of claim 11, further comprising:
extracting a target spectrum with an updated flow adjustment;
comparing a GLRT calculation target to a library of stored exceedance images;
applying a GLRT threshold;
filtering matches to clutter spectra based on GLRT spectra; and
filtering detections on clutter tracks.

18. The method of claim 11, further comprising:
populating a launch detection list.

19. The method of claim 11, further comprising:
capturing a video from at least two detectors, wherein a first director is a RGB video camera and a second detector is a LWIR video camera.

20. The method of claim 11, further comprising:
detecting a first target with a RGB video camera; and
detecting a second target with LWIR camera.
